(19) United States
(12) Patent Application Publication
(10) Pub. No.: US 2026/0103253 A1
(43) Pub. Date: Apr. 16, 2026

(54) LEG OF A HUMANOID ROBOT

(71) Applicant: Figure AI Inc., San Jose, CA (US)

(72) Inventors: Joseph Wood, San Jose, CA (US); Jacob Webb, San Jose, CA (US); David McCall, San Jose, CA (US); Sydney Hardy, San Jose, CA (US)

(21) Appl. No.: 19/323,751

(22) Filed: Sep. 9, 2025

Related U.S. Application Data
(60) Provisional application No. 63/705,944, filed on Oct. 10, 2024.
(60) Provisional application No. 63/705,778, filed on Oct. 10, 2024.
(60) Provisional application No. 63/767,281, filed on Mar. 5, 2025.
(60) Provisional application No. 63/785,183, filed on Apr. 8, 2025.
(60) Provisional application No. 63/839,880, filed on Jul. 7, 2025.
(60) Provisional application No. 63/839,474, filed on Jul. 7, 2025.
(60) Provisional application No. 63/839,479, filed on Jul. 7, 2025.
(60) Provisional application No. 63/850,760, filed on Jul. 25, 2025.
(60) Provisional application No. 63/875,074, filed on Sep. 3, 2025.
(60) Provisional application No. 63/874,723, filed on Sep. 3, 2025.
(60) Provisional application No. 63/875,558, filed on Sep. 4, 2025.

(51) Int. Cl. B62D 57/032; B25J 17/00

(52) U.S. Cl. CPC B62D 57/032; B25J 17/00

(57) ABSTRACT

This article is an interactive humanoid robot that consists of a head with a 3D face projected onto a mask, and communicates with its surrounding in the same way as humans do, by listening, observing, speaking, and expressing complex emotions. The robot is used in various contexts throughout society, for example, as a job training robot, a recruiter robot, a health pre-screening robot, etc.

### CROSS REFERENCE TO RELATED APPLICATIONS

This application claims the benefit of and priority to U.S. Provisional Patent Application Nos. 63/705,944 filed Oct. 10, 2024, 63/705,778 filed Oct. 10, 2024, 63/767,281 filed Mar. 5, 2025, 63/785,183 filed Apr. 8, 2025, 63/839,880 filed Jul. 7, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is hereby expressly incorporated by reference herein in its entirety.

### TECHNICAL FIELD

The present disclosure relates to a humanoid robot, and more particularly to the structure and capabilities of a portion of a leg of the humanoid robot.

### BACKGROUND

Humanoid robots are increasingly being developed for a wide range of applications, from manufacturing and logistics to personal assistance and exploration. A key capability for these robots is bipedal locomotion, which allows them to navigate human-centric environments, traverse complex terrain, and perform tasks that require mobility similar to that of a human. The development of effective bipedal locomotion is highly dependent on the design and functionality of the robot's feet, which serve as the primary interface between the robot and the ground.

Conventional robotic feet often struggle to replicate the complex mechanics of the human foot, leading to several limitations. Many existing designs provide rigid or semi-rigid platforms that are not well-suited for walking on uneven or compliant surfaces, resulting in instability and an increased risk of falling. This rigidity can also lead to inefficient energy transfer during the gait cycle, requiring more power and resulting in unnatural and noisy movements. Furthermore, the impact forces generated during walking and running are often poorly absorbed, which can transmit damaging shocks and vibrations throughout the robot's structure, potentially leading to premature wear and failure of mechanical and electronic components.

Additionally, existing humanoid robots face operational challenges related to maintenance and power management. Feet and their associated mechanisms are subject to significant wear and tear, but their integrated designs can make repair or replacement difficult and time-consuming. Moreover, recharging these robots often requires precise docking maneuvers or manual connection to a power source, which limits their autonomy and operational uptime. Therefore, there is a need in the art for a robotic foot that provides improved stability, adaptability, and shock absorption, while also addressing the practical challenges of maintenance and autonomous operation in real-world environments.

### SUMMARY

The presently disclosed subject matter is directed to a humanoid robot having a leg, and wherein said leg comprises a foot flex actuator coupled to a connecting rod. The leg comprises a foot that includes a pedestal having a toe coupling section and configured to pivot about a foot pitch axis in response to movement of the connecting rod. The foot includes a single toe structure having a lower curved surface, and hingedly coupled to the toe coupling section of the pedestal, the toe structure configured to pivot relative to the pedestal about a toe pivot axis. The foot includes a passive toe biasing device configured to bias the toe structure toward an initial position relative to the pedestal.

The presently disclosed subject matter is directed to a humanoid robot having a leg, and wherein said leg comprises a foot that includes a sole having a front portion and a rear portion. The foot includes a coupling portion positioned between the front portion and the rear portion. The foot includes a separation slit formed in the coupling portion, and wherein the separation slit is configured to allow relative movement between the front portion and the rear portion of the sole, when the foot moves from an initial position to a flexed position, and does not extend across the full width of the sole.

The presently disclosed subject matter is directed to a robot foot comprising a foot frame including a pedestal and a single toe structure, the single toe structure being hingedly coupled to a forward portion of the pedestal to define a toe pivot axis. The robot foot comprises a passive toe biasing device coupled between the pedestal and the single toe structure, the passive toe biasing device configured to apply a biasing force to maintain the single toe structure in an initial position and to allow the single toe structure to pivot about the toe pivot axis toward a flexed position when a compressive force greater than the biasing force is applied.

The presently disclosed subject matter is directed to a leg assembly for a robot, the leg assembly comprising a shin. The leg assembly comprises a talus pivotably coupled to a distal end of the shin at a first location, wherein the first location defines a foot pitch axis. The leg assembly comprises a foot flex actuator housed within the shin. The leg assembly comprises a connecting rod having a proximal portion operatively coupled to the foot flex actuator and a distal portion pivotably coupled to the talus at a second location, wherein, when the robot is in a neutral state, the second location is positioned rearward of and vertically elevated relative to the first location.

The presently disclosed subject matter is directed to a talus for a robot foot, the talus comprising a talus frame configured to serve as an articulating interface between a shin and a foot of the robot. The talus comprises a foot roll actuator, wherein the foot roll actuator is housed directly within an actuator receiving assembly of the talus frame such that the talus frame serves as a housing for the foot roll actuator, and wherein an outer surface of the talus frame is configured to act as a passive heat transfer surface for the foot roll actuator.

The presently disclosed subject matter is directed to a charging assembly for a robot foot, the robot foot having a pedestal with a first side and a second side, the charging assembly comprising a receiving coil module coupled to the second side of the pedestal. The charging assembly comprises a heat transfer device coupled to the second side of the pedestal and thermally coupled to the receiving coil module, wherein the pedestal includes a grate section on the first side configured to allow airflow to contact the heat transfer device for cooling.

The presently disclosed subject matter is directed to a sole for a robot foot having a pivoting toe structure, the sole comprising a sole base made of a deformable material, the sole base having a front portion and a rear portion. The sole comprises a separation slit formed through a coupling portion of the sole base between the front portion and the rear portion, wherein the separation slit is configured to allow relative movement between the front portion and the rear portion, and wherein the separation slit does not extend across a full width of the sole base, instead terminating at a perimeter rim of the sole.

The presently disclosed subject matter is directed to an enclosure for a robot foot, the robot foot having a foot frame with a pedestal and a toe structure, the enclosure comprising an interconnect assembly configured to be mechanically secured to the pedestal, the interconnect assembly comprising a pair of interconnect bridges and a heel coupler. The enclosure comprises a removable foot cover shaped to resemble a shoe upper, the foot cover including a locking trim assembly, wherein the locking trim assembly is configured to engage with the pair of interconnect bridges, the heel coupler, and cover coupling means on the toe structure to securely and removably attach the foot cover to the foot frame.

The presently disclosed subject matter is directed to a base assembly for a robot foot, comprising a pedestal having a first side and a second side, the second side being configured to couple with a wireless charging assembly. The base assembly comprises a coupling assembly projecting from the first side of the pedestal, the coupling assembly having an actuator mount configured to couple to an output portion of a foot roll actuator housed in a talus. The base assembly comprises a toe structure hingedly coupled to a toc coupling section of the pedestal.

In other embodiments, the humanoid robot foot may include a toe structure hingedly coupled to a pedestal. The foot's design can include a toe biasing device, which may feature a linear compression device such as a compression spring, a plunger, and a positioning rod, to apply a biasing force that returns the toe structure to an initial position defined by a mechanical stop. The magnitude of this biasing force is adjustable via a bias force adjustment mechanism, which may use a threaded engagement to alter the spring's preload. The pedestal can feature an internal channel to permit air to escape during toe movement, a grate section with apertures for airflow, and may be formed as a single monolithic part with its coupling assembly. The foot's talus frame, which can be machined from a monolithic part, includes dimensional features like fins or projections to increase surface area for heat dissipation and cooperates with a foot pitch limiter in the shin to prevent over-rotation.

The robot foot may incorporate a sole with distinct front and rear portions, separated by a non-continuous, flattened U-shaped separation slit that allows for relative movement and flexion, a motion which can be resisted by a spring. This slit does not extend across the full width of the sole. The sole may be covered by a continuous elastic outsole layer that stretches or has an extension portion that folds into the slit. A removable foot cover, comprising a semi-rigid carrier with an adhered external textile layer (potentially with multiple texture zones), can be attached and detached without removing the robot's leg. This cover is secured by a locking trim assembly and an interconnect assembly, the latter of which is mechanically secured to the pedestal and includes openings for cooling airflow to exit.

Furthermore, the foot can be equipped with a wireless charging assembly located at a lower extent than the pedestal. This assembly includes a receiving coil thermally coupled to a heat transfer device, such as heat pipes or vapor chambers. A multi-layer coil shield, which can include a nanocrystalline material for electromagnetic shielding and a polyimide film for thermal insulation, is positioned between the receiving coil and the pedestal, partially surrounding the coil. A dedicated airflow path facilitates cooling by drawing air from the robot's shin, forcing it through openings in the pedestal to contact the heat transfer device, and expelling it through the opening in the interconnect assembly.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a perspective view of a lower leg assembly of the robot of FIGS. 1-3B, including a shin, a talus, and a foot, wherein the knee actuator, foot flex actuator, and foot roll actuator are contained within the lower leg assembly;

FIG. 7 is a side view of the foot of the lower leg assembly of FIG. 6, wherein the foot is coupled to the shin via the talus, and a foot enclosure substantially encloses a base assembly and the talus;

FIG. 8 is an exploded view of the foot of FIG. 7, showing: (i) a base assembly including: (a) a foot frame, (b) a toc biasing device, and (c) a charging assembly, and (ii) a foot enclosure including: (a) a sole, (b) a cover interconnect assembly, and (c) a foot cover, wherein the foot cover includes a carrier, a locking trim assembly, and a textile layer;

FIG. 9 is a side view of the textile layer of the foot cover of FIG. 8;

FIG. 10 is a bottom perspective view of the textile layer of FIG. 9;

FIG. 11 is a bottom view of the foot cover of FIG. 8, showing the relationship of the carrier and locking trim assembly with the textile layer, where the locking trim assembly includes left and right side locking trim and a front locking trim;

FIG. 12 is a cross-sectional view of the foot cover taken along line 12-12 of FIG. 11;

FIG. 13 is a perspective view of a pair of coupling bridges of the cover interconnect assembly of FIG. 8, showing the interior portion of a right side coupling bridge and the exterior portion of a left side coupling bridge;

FIG. 14 is a perspective view of the interior portion of a right side coupling bridge of FIG. 13;

FIG. 15 is a side view of the interior portion of a right side coupling bridge of FIG. 13;

FIG. 16 is a perspective view of the sole of FIG. 8, wherein the sole includes a toc portion and main portion with a slit formed therebetween;

FIG. 17 is a bottom view of the sole of FIG. 16;

FIG. 18 is a top view of the sole of FIG. 16;

FIG. 19 is a top view of the foot enclosure of FIG. 8, including the foot cover coupled to the cover interconnect assembly and the sole, where the cover interconnect assembly includes the pair of coupling bridges and a heel coupler;

FIG. 20 is a cross-sectional view of the foot enclosure along line 20-20 of FIG. 19;

FIG. 21 is a zoomed-in view of the sole at the slit of FIG. 20;

FIG. 22 is a perspective view of the base assembly coupled to the foot roll actuator of FIG. 8, where the foot frame includes a pedestal, a coupling assembly, and a toe structure;

FIG. 23 is a side view of the foot of FIG. 22;

FIG. 24 is a cross-sectional view of the foot taken along line 24-24 of FIG. 7;

FIG. 25 is a perspective cross-sectional view of the foot of FIG. 24;

FIG. 26 is a rear perspective view of an extent of the lower leg of FIG. 6, shown bent at the toe joint;

FIG. 27 is a perspective view of the pedestal of the base assembly of FIG. 22;

FIG. 28 is a side view of the pedestal of FIG. 27;

FIG. 29 is a rear perspective view of the toe structure of FIG. 22;

FIG. 30 is a side view of the toe structure of FIG. 29;

FIG. 31 is a perspective cross-sectional view of the foot taken along line 31-31 of FIG. 7;

FIG. 32 is a front cross-sectional view of the foot of FIG. 31;

FIG. 33A is a first cross-sectional view of an extent of the lower leg of FIG. 6 in a neutral state, and taken along a reference plane that includes the rotational axis of the foot roll actuator;

FIG. 33B a second cross-sectional view of an extent of the lower leg of FIG. 6 in a neutral state, and taken along the reference plane;

FIG. 34 is a cross-sectional view of an extent of the lower leg of FIG. 26 in a walking state, and taken along the first reference plane that includes the rotational axis of the foot roll actuator;

FIG. 35 is an exploded view of the charging module;

FIG. 36 is the robot of FIG. 3A shown in relation to a wireless charging system;

FIG. 37 is a cross-sectional view of a second embodiment of the foot, showing an alternative sole for the foot enclosure;

FIG. 38A is a zoomed-in view of the sole at the slit of the foot enclosure in FIG. 37;

FIG. 38B is a zoomed-in view of the sole at the slit of the foot enclosure in a further alternative configuration;

FIG. 39 is a cross-sectional view of a third embodiment of the foot, showing an alternative toe biasing arrangement; and

FIG. 40 is a cross-sectional view of a fourth embodiment of the foot, showing an alternative toe biasing arrangement and an alternative arrangement for pitch and roll actuation of the foot.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The foot assembly disclosed in this Application is designed to be a component of a humanoid robot. The complexity of bipedal locomotion demands a sophisticated design, particularly in the feet, which serve as the crucial interface between the robot and the world. A truly effective foot assembly must not only support the robot's weight but also adapt to uneven surfaces, absorb impacts, and facilitate a smooth, natural gait. Addressing these requirements is fundamental to developing robots that can operate safely and efficiently alongside people.

The disclosed foot assembly extends from the leg assembly of the robot. In particular, the lower leg of the robot includes shin coupled to the knee actuator, a talus coupled to the shin, and a foot coupled to the talus. In other words, the foot is indirectly coupled to the shin via the intermediate talus. The indirect coupling of the foot to the shin allows the foot to move independently of the shin. This provides the disclosed robot with greater flexibility and control over the position of the foot. The disclosed lower leg arrangement is beneficial over the arrangement in conventional robots that directly couples the foot to the shin. Said conventional robots can only control the roll of the foot using an actuator contained in the robot's shin.

A key advantage lies in its unique approach to movement and balance. The design utilizes a single, fixed foot pitch axis that extends across the majority of the foot, providing a more stable and predictable pivot point compared to conventional multi-pivot designs. This is complemented by a hinged toe structure that is passively returned to its initial position by a biasing device, a feature that allows for more fluid motion during walking. Paired with integrated force sensors that provide real-time feedback for balance adjustments, the foot enables the robot to navigate dynamic and uneven terrain with confidence.

Beyond its mechanical ingenuity, the design prioritizes operational autonomy and case of maintenance. Each foot is equipped with a wireless charging system, allowing the robot to recharge simply by standing on a transmitter pad, thus eliminating the need for cumbersome cables or precise docking maneuvers. This system offers both faster charging and redundancy, as one foot can continue to charge if the other's module fails.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

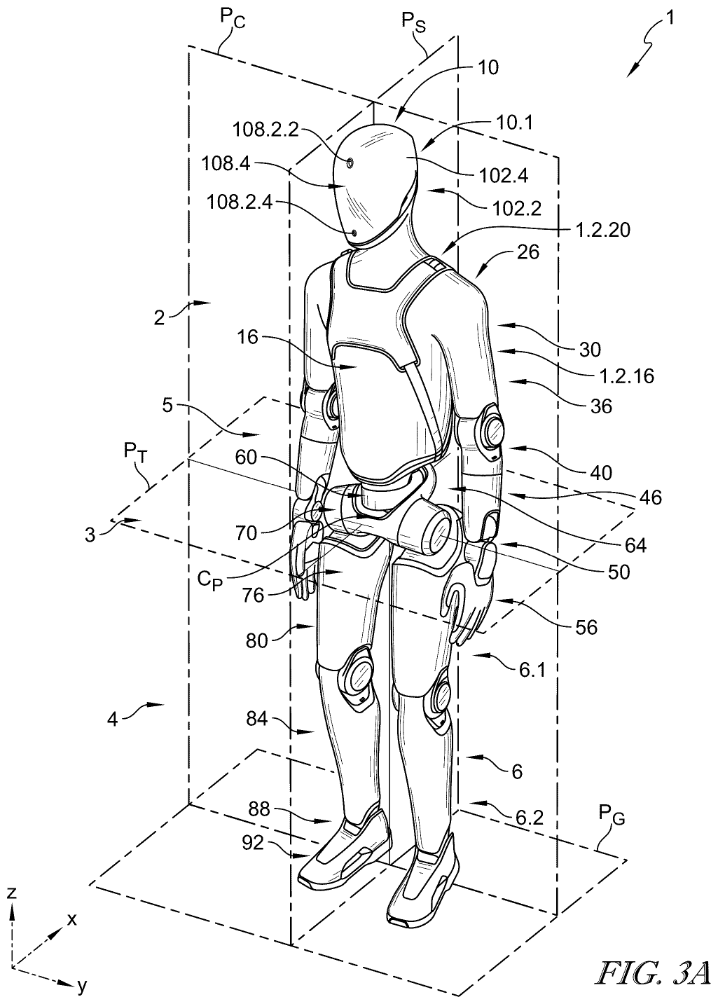

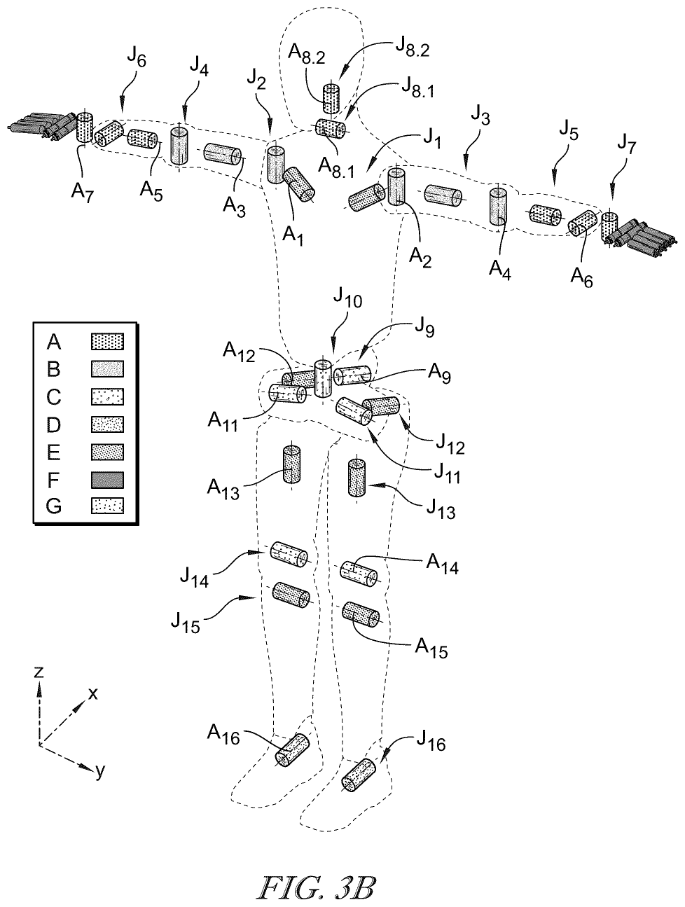

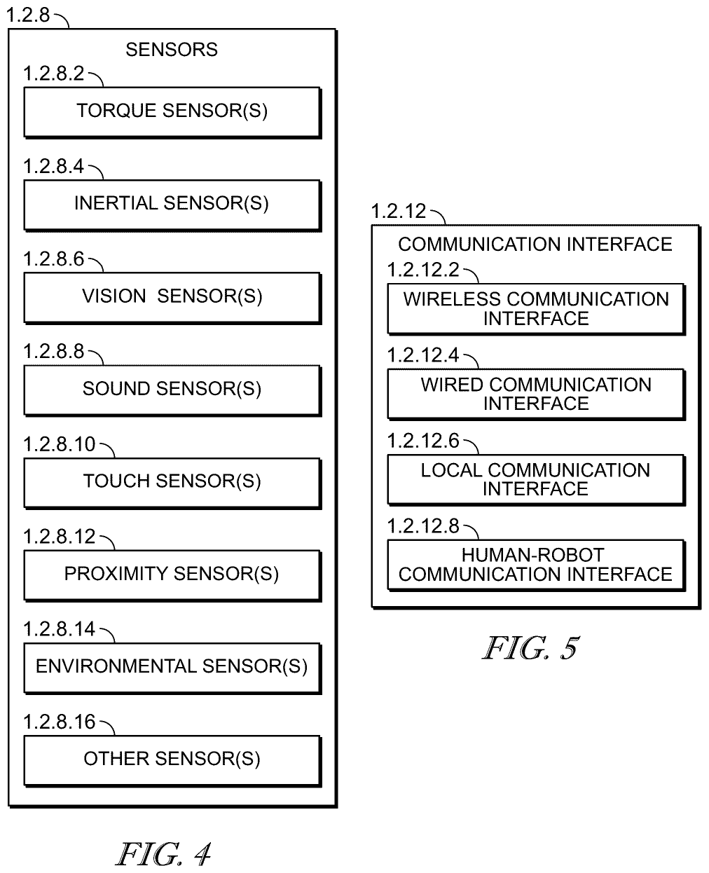

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its fect. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high clastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

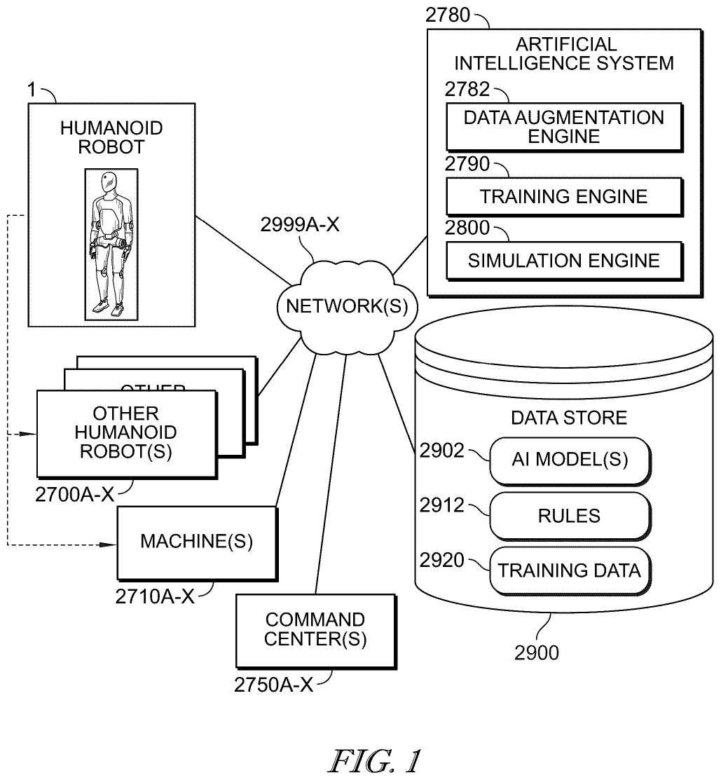

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot I may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot I may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot I to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots I may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

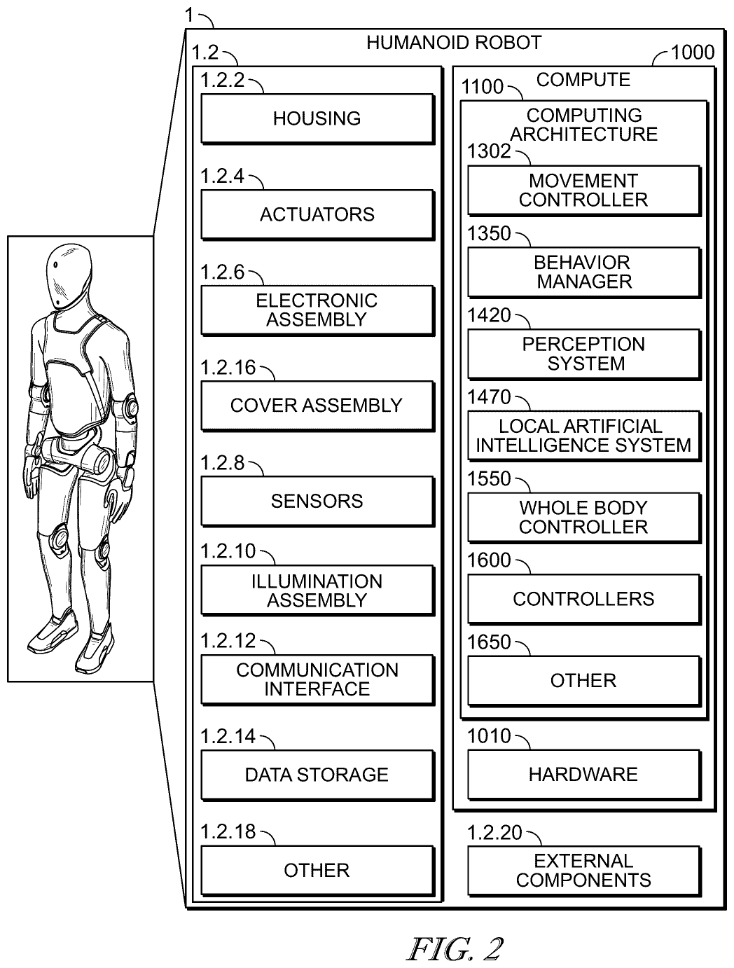

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot I may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as checks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot I to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 may include a plurality of subsystems, such as: (i) high-torque electric actuators, (ii) interconnected structural assemblies, and (iii) other integrated structures and/or components (e.g., hard-stops to prevent joint over-rotation, internal cooling channels for thermal management of the actuators, and passive heat sinks to dissipate waste heat). The selection of specific materials, the design of structural components, and the arrangement of sub-assemblies are all implemented to achieve a desired balance of strength, weight, and dynamic performance as described herein.

Referring to FIGS. 3A-3B, the left and right leg 6 of the robot I includes an upper leg assembly 6.1 and a lower leg assembly 6.2. The lower leg assembly 6.2 is coupled to the upper leg assembly 6.1 via a knee actuator (J14) 820. The upper leg assembly 6.1 includes a hip flex actuator (J11) 720 for forward and backward leg movement and a hip roll actuator (J12) 768 for lateral leg movement, both of which may be contained within the hip assembly 70. Additionally, a leg twist actuator (J13) 782 is at least partially housed in the upper thigh 76 and is coupled to the lower thigh 70. The rotational axis A₁₃ of this leg twist actuator (J13) 782 defines a primary leg axis A_{L} about which the entire lower leg can rotate, particularly when the robot 1 is in a default, neutral standing state. The lower leg assembly 6.2 is a highly integrated unit that includes the knee actuator (J14) 820, which is substantially contained within the shin 84 and coupled to the lower thigh 70. It also includes a foot flex actuator (J15) 860, which is housed within the shin 84 to control the pitch motion of the foot. A foot roll actuator (J16) 900 is housed within the talus 88, and the foot 92 is coupled to said talus 88. The individual actuators J11-J16 may be operatively connected to a hierarchical control system, which may include one or more controllers, such as a movement controller 1302, a whole-body controller 1550 that coordinates motion across the entire robot, and other specialized controllers 1600 for tasks such as balancing or power management.

a. Lower Leg Assembly

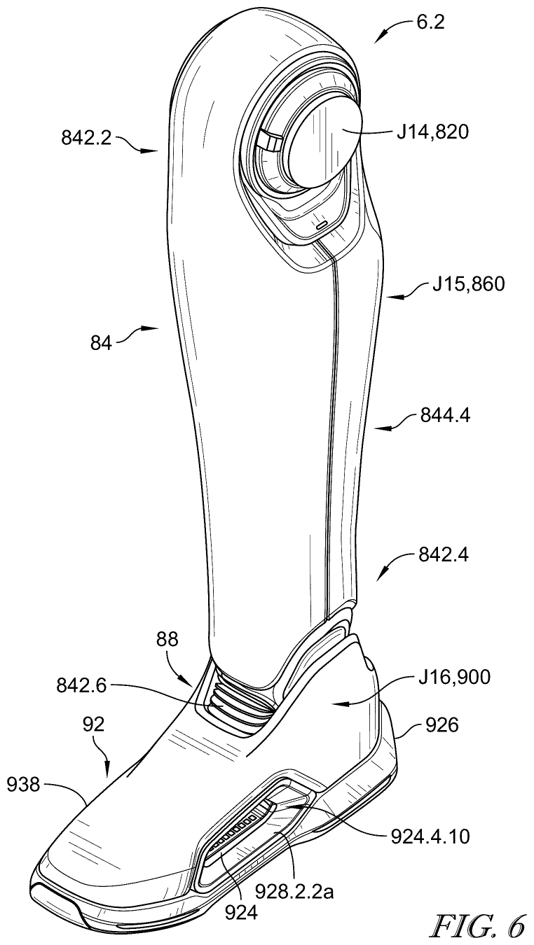

Referring to FIG. 6, the lower leg assembly 6.2 includes the shin 84, the talus 88, and the foot 92. The knee actuator (J14) 820 is substantially contained in a proximal portion of the shin 84 and is mechanically coupled to the lower thigh 70. The talus 88 serves as an articulating interface, being coupled between the distal end of the shin 84 and the foot 92. The foot flex actuator (J15) 860, which is housed within the shin 84, controls the pitch movement (dorsiflexion and plantar flexion) of the foot 92 through its connection to the talus 88. The foot roll actuator (J16) 900, housed directly within the talus 88, controls the roll movement (inversion and eversion) of the foot 92.

i. Shin

Referring to FIGS. 6 and 33A-34, the shin 84 includes a structural shin frame 844, which may be machined from a lightweight, high-strength material such as an aluminum alloy or may include plastic. This frame 844 is configured with internal mounting features to securely contain the knee actuator (J14) 820 and the foot flex actuator (J15) 860. The knee actuator (J14) 820 is substantially housed within a proximal portion 842.2 of the shin 84 and controls the angular position of the lower leg assembly 6.2 with respect to the upper leg assembly 6.1, enabling actions (e.g., leg bends at the knee). The foot flex actuator (J15) 860 is contained within a housing 842 of the shin 84 and is operatively coupled to a connecting rod 872 that drives the pitch movement of the foot 92. A proximal portion 872.2 of the connecting rod 872 is coupled to the output of the foot flex actuator (J15) 860 within the shin 84, and a distal portion 872.4 of the connecting rod 872 extends through a distal opening 844.4.8 formed in a distal portion 842.4 of the shin 84 and is pivotably coupled to the talus 88.

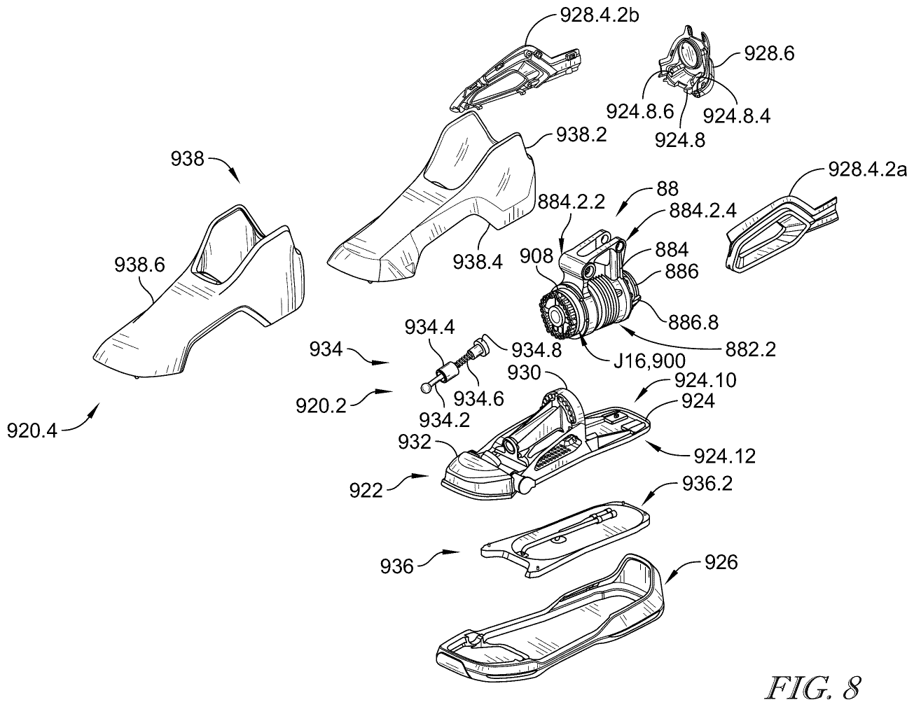

Referring to FIGS. 8 and 33A-34, the foot 92 is coupled to the talus 88 and cooperates with the talus 88 to support the robot 1 on a support surface. The shin 84 is directly coupled to the talus 88 at two distinct locations to form a robust, articulated joint. In particular, the shin frame 844 is pivotably coupled to the talus 88 at a primary shin coupling mount 884.2.2, defining a pitch axis. Additionally, the distal portion 872.4 of the connecting rod 872, which transmits the force from the actuator, is pivotably coupled at a separate connecting rod mount 884.2.4 on the talus 88. However, the shin 84 is not directly coupled to the foot 92 itself. Instead, the foot 92 is indirectly coupled to the shin 84 and, by extension, to the foot flex actuator (J15) 860, via the intervening talus 88. Specifically, the foot 92 is coupled to the output portion 908 of the foot roll actuator (J16) 900, which is housed within the talus 88.

The foot 92 is coupled to the foot roll actuator (J16) 900 housed in the talus 88; thus, the pitch angle of the foot 92 moves in unison with a change of pitch of the talus 88, as actuated by the foot flex actuator (J15) 860 and the connecting rod 872. Additionally, the foot roll actuator (J16) 900 independently drives the roll movement of the foot 92 relative to the talus 88. The lower leg assembly 6.2 does not include a dedicated actuator for yaw movement of the foot 92. Instead, the leg twist actuator (J13) 782, housed in the upper leg assembly 6.1, is configured to control the rotation (e.g., yaw) of the entire lower leg assembly 6.2, including the foot 92, about the leg axis A_{L}.

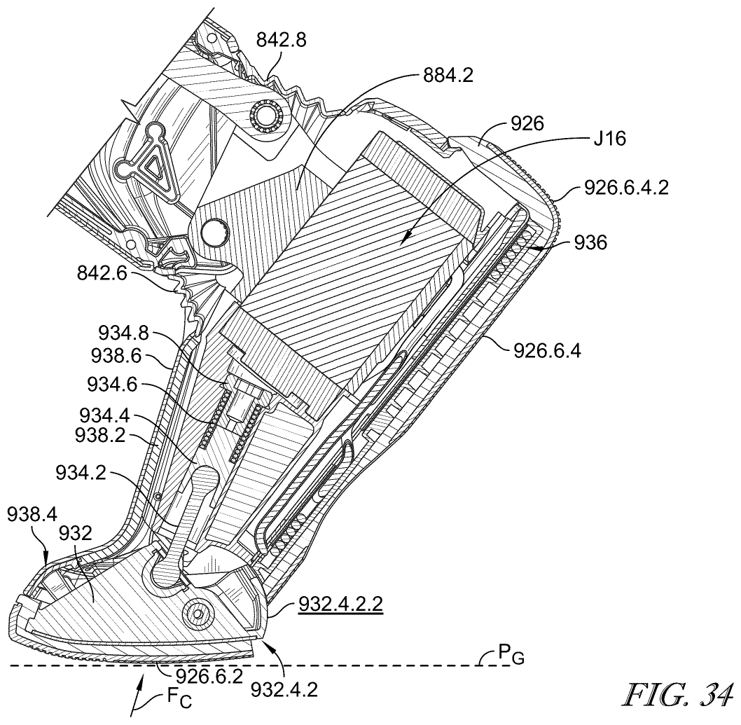

Referring to FIG. 34, the foot flex actuator (J15) 860, housed within the shin 84, drives the pitch movement of the foot 92 via the connecting rod 872 about a defined foot pitch axis (AFP). In the illustrated embodiment, a foot pitch limiter 844.10, which may be an integrally machined feature, is formed within the shin frame 844. This limiter is configured to cooperate with a corresponding surface on the talus frame 884 to mechanically limit over-rotation of the foot 92 beyond a predefined range of motion, particularly in plantar flexion (when the toe box is pointed down). The foot roll actuator (J16) 900, coupled to the talus 88, is configured to control the roll movement of the foot 92 relative to the shin 84 about its rotational axis (A 16). In the illustrated embodiment, a roll limiter 924.8 of the foot 92 includes a first and second limit wall 924.8.4, 924.8.6 that acts as a physical hard-stop. This limiter cooperates with a heel interface 886 of the talus 88 to limit over-rotation of the foot 92 in both roll directions, preventing mechanical damage to the actuator or joint.

In various embodiments, one or more hard stops may be included in the shin 84, talus 88, and/or foot 92, where the hard stops in combination with limiters provide an external limitation of rotation to the movement driven by associated actuators. In other embodiments, an alternative arrangement of foot pitch and/or roll actuators may reside in the shin 84 and cooperate with the talus 88 to change the pitch and roll of the foot 92. In some embodiments, the foot flex actuator (J15) 860 may be a linear actuator, such as a ball screw or electric cylinder, instead of a rotary actuator.

In various embodiments, the shin 84 may include front and rear coupling shrouds 842.6, 842.8 that extend from the distal portion 842.4 of the shin 84. These shrouds interface with the foot cover 938 to surround and protect the connection of the shin 84 to the talus 88 from debris. In the illustrative embodiment, the front and rear coupling shrouds 842.6, 842.8 are fabricated from a flexible and/or deformable material, such as an elastomer, to allow them to expand or contract with the change of pitch of the foot 92 without impeding motion.

ii. Talus

Referring to FIGS. 8 and 34, the talus 88 includes (i) a talus housing 882 and (ii) the foot roll actuator (J16) 900 integrated within it. The talus housing 882 further includes (i) a talus frame 884 having (a) an actuator receiving assembly 884.6 and (b) a shin coupling assembly 884.2, and (ii) a heel interface 886. The foot roll actuator (J16) 900 is housed directly in the actuator receiving assembly 884.6 and is coupled directly to the talus frame 884. In other words, the foot roll actuator (J16) 900 does not have a separate actuator housing within the talus housing 882; rather, the talus frame 884 itself serves as the actuator housing. This functional integration reduces part count, weight, and assembly complexity. In various embodiments, the talus frame 884 may include an outer surface 882.2 that is configured with dimensional features (e.g., fins, projections, peaks and valleys, or other structures) to increase the surface area. This enhanced surface area allows the talus frame to act as a passive heat transfer surface, or heat sink, for the foot roll actuator (J16) 900. The output portion 908 of the foot roll actuator (J16) 900 is forward-facing and is configured to couple directly to the foot 92. A rearward-facing portion of the foot roll actuator (J16) 900 is covered by a heel interface 886 that is coupled to the talus frame 884. The heel interface 886 is designed to at least partially enclose the foot roll actuator (J16) 900 at the rear and to cooperate with the roll limiter 924.8 of the foot 92 when the foot 92 rotates with respect to the talus 88. For example, the heel interface 886 may include one or more projections 886.8 that interface with the limit walls 924.8.4, 924.8.6 of the roll limiter 924.8 (see FIG. 8).

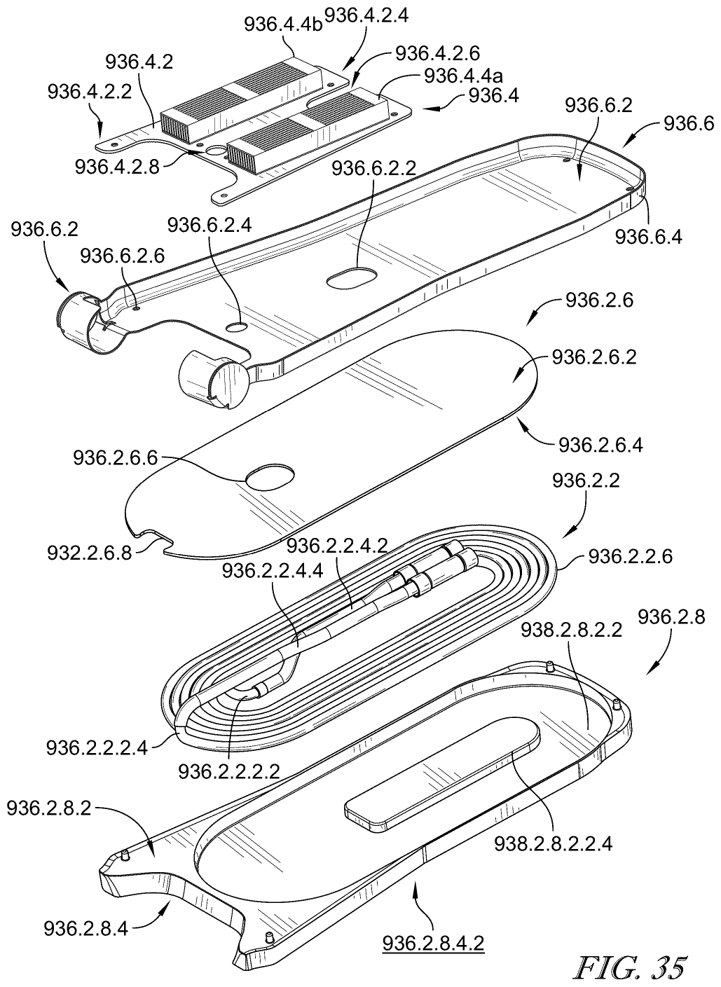

Referring to FIGS. 34-35, the shin coupling assembly 884.2 of the talus 88 includes (i) a shin coupling mount 884.2.2 at a first location (L₁) and (ii) a connecting rod mount 884.2.4 at a second location (L₂). The shin coupling mount 884.2.2 is configured to receive a shin frame mounting pin from a foot coupling assembly of the shin 84, thereby pivotably coupling the shin frame 844 to the talus 88. The shin coupling mount 884.2.2 may be formed in a top central section of the talus frame 884. The shin coupling mount 884.2.2 may include a shin coupling aperture 884.2.2.2 formed in a solid portion of the talus frame 884, where the center of the shin coupling aperture 884.2.2.2 defines the first location (L₁) and a foot pitch axis (A_{FP}). The shin coupling mount 884.2.2 is configured such that a coupling portion of the shin 84 straddles the shin coupling mount 884.2.2 of the talus 88, so that the shin mounting apertures of the shin frame 844 align with the shin coupling aperture 884.2.2.2 to receive the shin frame mounting pin therethrough. In various embodiments, the shin frame mounting pin may include roller bearings on each end to facilitate motion, and the shin frame 844 may further include bearing seats to house the roller bearings.

The connecting rod mount 884.2.4 of the talus 88 is configured to pivotably couple with the connecting rod 872. The connecting rod mount 884.2.4 may include two parallel arms spaced apart and extending rearward from the shin coupling mount 884.2.2. Each arm of the connecting rod mount 884.2.4 includes apertures 884.2.4.4 configured to receive a rod pivot pin, which in turn defines a rod pivoting axis (A_{15-R2}). The two arms 884.2.4.2 are spaced apart to receive the distal end 872.4 of the connecting rod 872 therebetween, such that the rod pivot pin may be received in the aperture 872.4.2 and bearings 872.4.4 (e.g., spherical bearings) of the connecting rod 872.

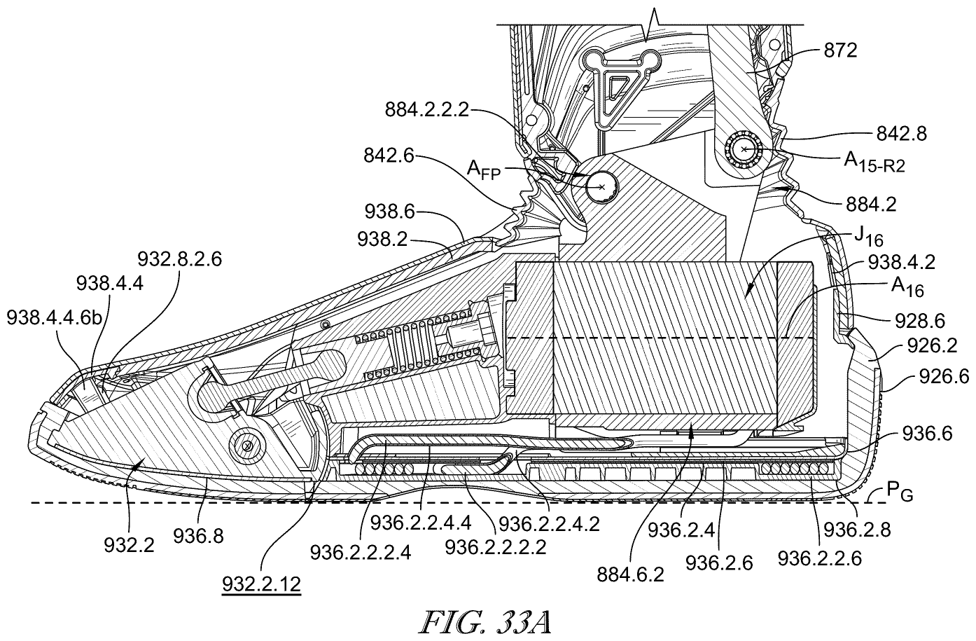

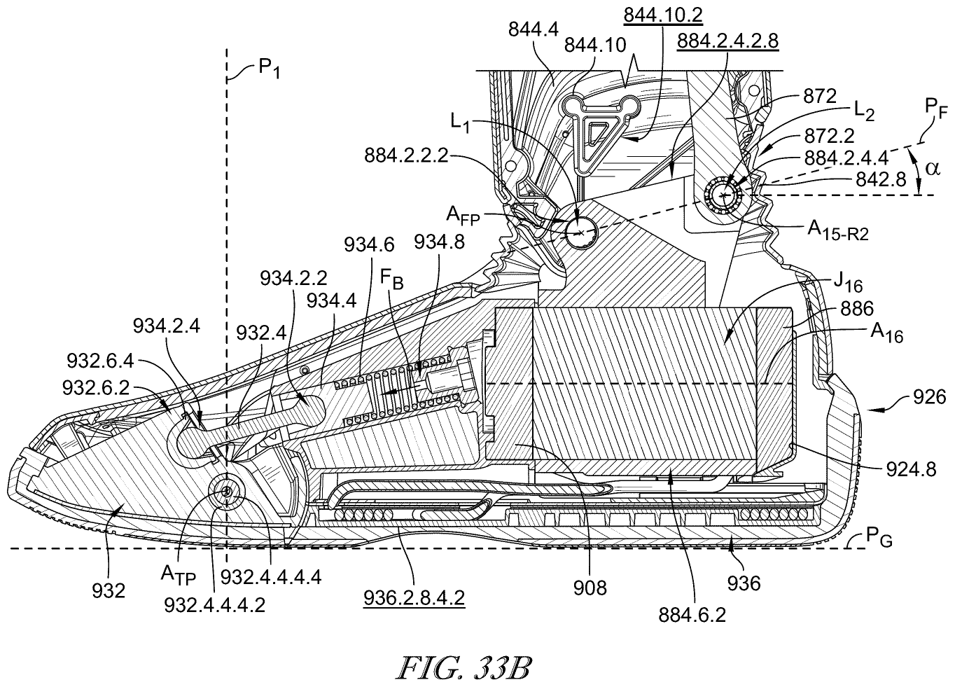

The shin frame 844 is coupled to the talus 88 at a first location L₁ (e.g., shin coupling aperture 884.2.2.2), and the connecting rod 872 is coupled to the talus 88 at a second location L2 (e.g., rod coupling apertures 884.2.4.4), wherein the second location (L₂) is (i) positioned rearward of the first location (L₁) and (ii) vertically elevated relative to the first location (L₁ when the robot is in its neutral state. Specifically, a plane (P_{F}) that includes both the foot pitch axis (A_{FP}) and the rod pivoting axis (A_{15-R2}) is angled relative to the support surface PG when the robot is in the neutral state. This angle, denoted as alpha (α) (as shown in FIG. 33B), can be between about 1 and 40 degrees, and is preferably between about 15 and 25 degrees, to optimize the moment arm and mechanical advantage of the actuator throughout the range of motion. This specific positional relationship, combined with the fact that the first location (L₁) is fixed relative to the shin, causes the foot to rotate or be angularly displaced about the first location (L₁) when the connecting rod is actuated. This rotation or angular displacement occurs precisely along the foot pitch axis (A_{FP}), which is centered at the first location (L₁). The positional relationship of the first and second locations (L₁, L₂) and the fact that the foot pitch axis (A_{FP}) extends across most of the width of the foot provides substantial benefits over conventional robot legs that may include multiple, less stable pivot points and lack a single, well-defined axis that extends across the majority of the foot's width.

When the robot 1 is standing in a neutral state, the center of the rod coupling apertures 884.2.4.4 for coupling the connecting rod 872 is positioned at a predefined horizontal and vertical distance from the shin coupling aperture 884.2.2.2 for coupling the shin frame 844. The shin frame 844 is pivotably fixed at the first location (L₁), defining the foot pitch axis (A_{FP}) about which the foot 92 pivots. As illustrated, the rod coupling apertures 884.2.4.4 at the second location (L₂) are positioned rearward (providing a horizontal distance) and upward (providing a vertical distance) from the shin coupling aperture 884.2.2.2 at the first location (L₁). This specific offset is engineered to provide a specified range of motion and a desired torque profile. For example, the horizontal separation may be between 38 and 58 mm, preferably between 43 to 53 mm, and the vertical separation may be between 11 and 17 mm, preferably between 12.3 to 15.4 mm.

In the illustrated embodiment, a foot pitch limiter 844.10 is formed within the shin frame 844 and is configured to cooperate with the talus frame 884 to mechanically limit over-rotation of the foot 92. For example, the foot pitch limiter 844.10 may have a contact surface 844.10.2 that is spaced from and faces a corresponding talus contact surface 884.2.4.2.8. When the foot 92 is pitched downward (plantar flexion), the foot pitch limiter 844.10 is positioned to limit over-rotation of the talus 88 and the attached foot 92 by providing an external, high-force hard stop when the talus contact surface 884.2.4.2.8 makes contact with the contact surface 844.10.2.

iii. Foot

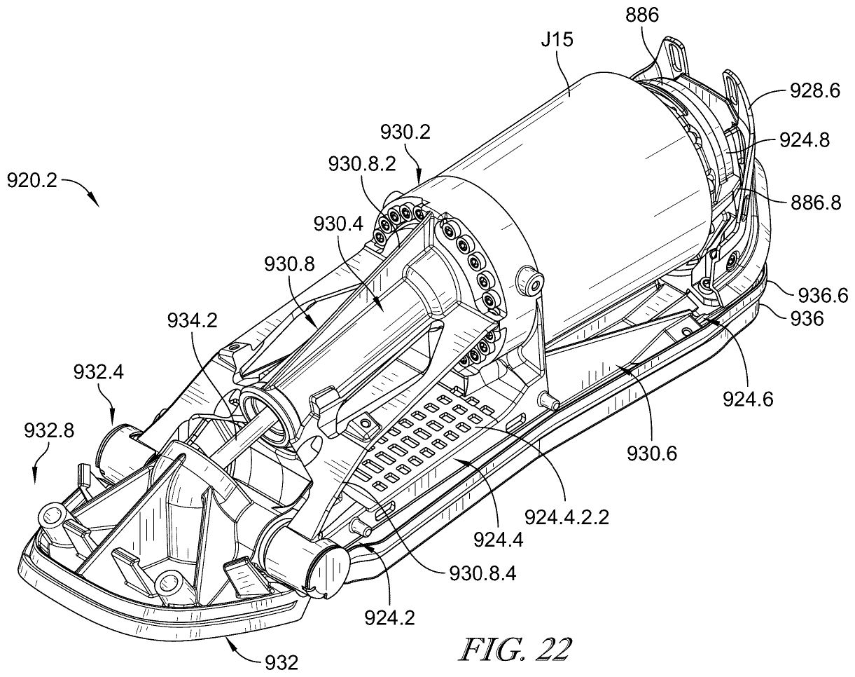

Referring to FIGS. 6-8, 19-23, and 33A-34, the foot 92 is coupled to and substantially surrounds the talus 88. The foot 92 is a multi-component assembly that includes a base assembly 920.2 and a foot enclosure 920.4. The base assembly 920.2 is primarily composed of the internal mechanical and electrical structures and components of the foot 92. As such, the base assembly 920.2 is configured to operatively couple the foot 92 to the talus 88 and includes (i) a structural foot frame 922, (ii) a toe biasing device 934, and (iii) a charging assembly 936. Meanwhile, the foot enclosure 920.4 is primarily composed of the exterior portions of the foot, which are designed to surround and/or enclose a majority of the base assembly 920.2 for protection and aesthetics. As such, the foot enclosure 920.4 includes (i) a deformable sole 926, (ii) an interconnect assembly 928, and (iii) a removable foot cover 938. While the foot 92 is disclosed as having all of these assemblies, components, and/or parts, it should be understood that in alternative embodiments, one or more of these parts may be replaced, omitted, changed, or incorporated into another assembly, component, and/or part. For example, in a simplified embodiment, the foot enclosure 920.4 may be omitted or partially omitted, leaving the base assembly 920.2 exposed for certain applications.

Referring to FIGS. 19 and 33B, portions of the foot 92 may be described with respect to a set of reference planes that are defined when the robot 1 is in the neutral state. In the illustrative embodiment, the foot 92 and talus 88 are substantially symmetrical about a first reference plane P_{F1}. This is a vertical plane that includes the axis A₁₆ of the foot roll actuator (J16) 900 and is parallel to the sagittal plane P_{S} of the robot 1. A second reference plane P_{F2} is a vertical plane that includes the toe pivot axis A_{TP}. This plane is perpendicular to the first reference plane P_{F1} and is parallel to the coronal plane P_{C} of the robot 1.

### 1. Base Assembly

As discussed above, said base assembly 920.2 includes (i) a foot frame 922, (ii) a toc biasing device 934, and (iii) a charging assembly 936. The foot frame 922 includes a pedestal 924, a coupling assembly 930, and a single toc structure 932. The coupling assembly 930 may be coupled to or formed in one piece with the pedestal 924. The coupling assembly 930 projects from a first side 924.10 of the pedestal 924 and is configured to couple to the output portion 908 of the foot roll actuator (J16) 900 housed in the talus 88. The toe structure 932 is hingedly coupled to the pedestal 924 and is configured to pivot about a toe pivot axis (A_{TP}). The toc biasing device 934 is received within an extent of the coupling assembly 930 and extends to interface with the toe structure 932. The charging assembly 936 couples to a second side 924.12 of the pedestal 924.

a. Foot Frame

Referring to FIG. 8, the foot frame 922 includes a pedestal 924, a coupling assembly 930, and a toe structure 932. The pedestal 924 is an elongated platform having a toe coupling section 924.2, a forward platform section 924.4, and a rear platform portion 924.6. The pedestal 924 is further defined by a first side 924.10, which interfaces with the talus, and a second side 924.12, which faces the sole. The coupling assembly 930 is mounted on the first side 924.10 of the pedestal 924. In the illustrative embodiment, the pedestal 924 and the coupling assembly 930 are formed together as a single monolithic part, for example by CNC machining of casting, to maximize strength and minimize weight. In other embodiments, the pedestal 924 and the coupling assembly 930 may be formed as separate components and subsequently secured to each other using fasteners or bonding agents. The coupling assembly 930 includes an actuator mount 930.2 for the foot roll actuator, a forward coupling frame 930.8, and a rear support 930.6 for structural reinforcement. The forward coupling frame 930.8 also includes a biasing interface 930.4 which is specifically designed to receive and house the toe biasing device 934. The pedestal 924 is further configured to couple with the charging assembly 936 on its second side 924.12. The toe structure 932 is pivotably coupled to the toe coupling section 924.2 of the pedestal 924. This connection forms a toe joint and defines an axis (ATP) about which the toc structure 932 is able to pivot. The toe structure 932 is operatively connected to the pedestal 924 via the toe biasing device 934. This passive device allows the toe structure 932 to move under load and then automatically returns it to a predetermined initial state when the load is removed.

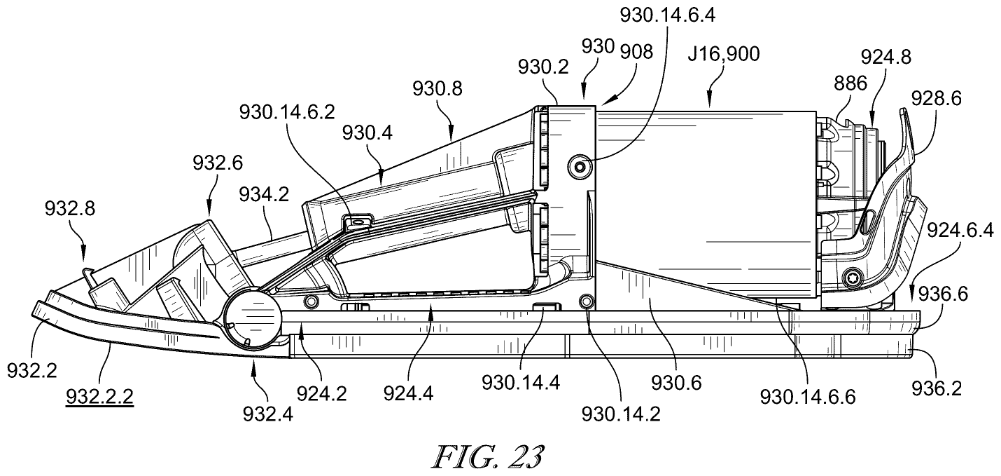

Referring to FIG. 23, when the charging assembly 936 is coupled with the pedestal 924, the lower surface 932.2.12 of the toe structure 932 aligns with the lower surface 936.2.8.4.2 of the charging module 936.2, forming a relatively flat plane that is then received into the sole 926.

i. Pedestal

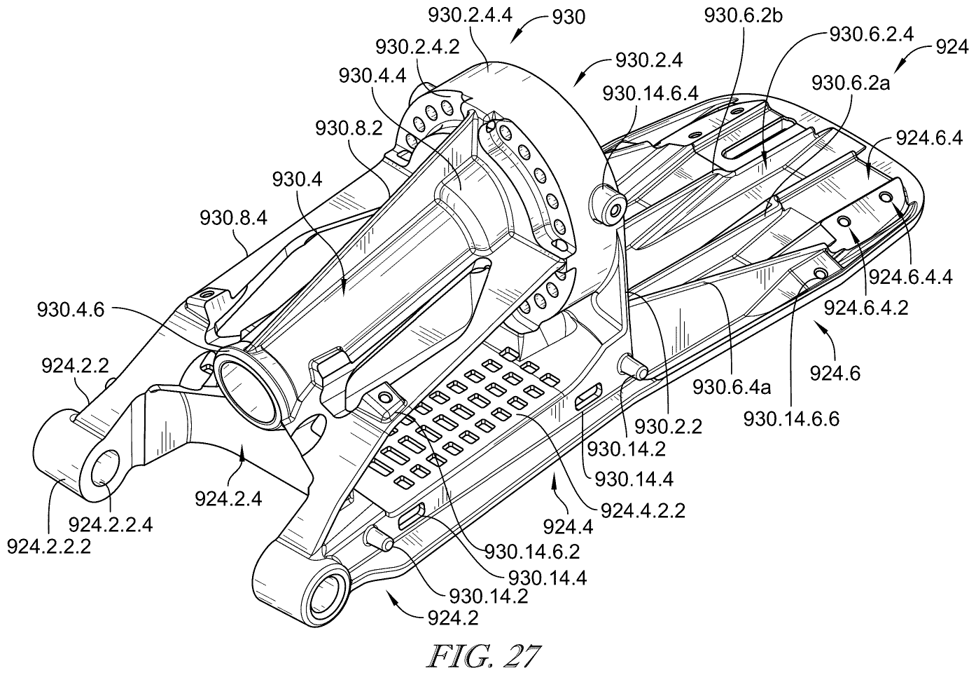

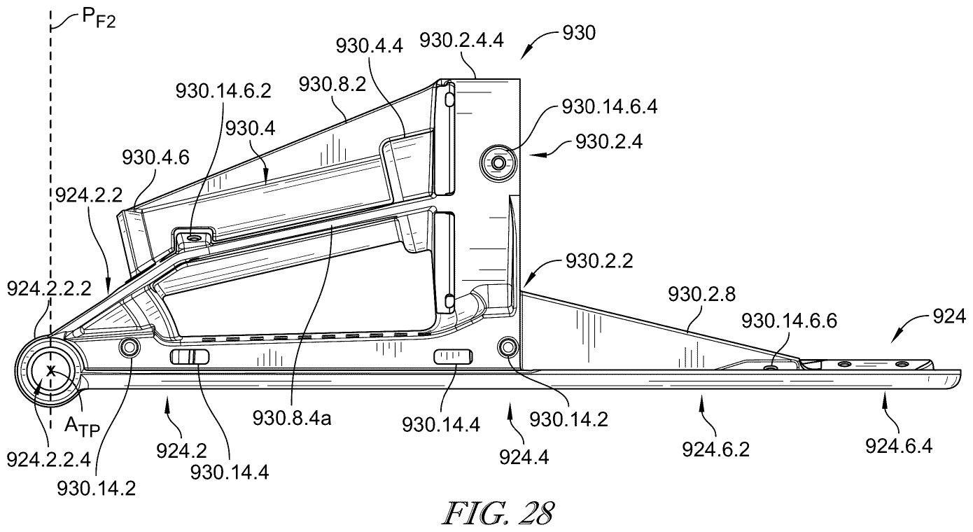

Referring to FIGS. 27-28, the pedestal 924 includes an elongated platform having a forward toe coupling section 924.2, a central forward platform section 924.4, and a rear platform section 924.6. The actuator mount 930.2 projects from the first side 924.10 of the pedestal 924, originating from a reinforced central base portion 924.4.4. The rear platform portion 924.6 is defined as the section of the pedestal rearward of the actuator mount 930.2. The pedestal 924 further includes a roll limiter 924.8 that couples to the rear platform portion 924.6. This component is configured to interface with the heel interface 886 of the talus 88 to physically limit the roll motion of the foot 92.

The toe coupling section 924.2 is located at the forward-most portion of the pedestal 924 and includes a pair of coupling projections 924.2.2 configured to pivotably couple with the toc structure 932, and a coupling wall 924.2.4 configured to guide the movement of the toc structure 932. The coupling wall 924.2.4 may include a limit projection 924.2.4.2.2 that interacts with an edge 932.4.2.4 of the arcuate interface wall 932.4.2.2 of the toe structure 932 to arrest downward movement. The pair of coupling projections 924.2.2 includes joint coupling portions 924.2.2.2.2 with through-openings 924.2.2.4 dimensioned to receive frame coupling means 932.4.4.

The forward platform section 924.4 includes a planar section 924.4.2, and side frame sections 924.4.2.4 that project downward from the planar section, defining a compartment 924.4.8 under the planar section 924.4.2. The planar section 924.4.2 includes a grate section 924.4.2.2 (e.g., comprising perforations, a grating, or a plurality of apertures) to allow for airflow or ventilation, which is used for cooling the electronics (e.g., coil) housed within the foot. In some embodiments, the grate section 924.4.2.2 may be a separate insert, and the planar section 924.4.2 may be configured with a corresponding opening to receive this grate insert portion. A pair of central supports 924.4.6 spans the length of the forward platform section 924.4. These supports provide structural reinforcement and also form a wire channel for routing the first and second end leads 936.2.2.2.2, 936.2.2.2.4 of the receiving coil module 936.2. The compartment 924.4.8 is configured to receive the heat transfer device 936.4 of the charging assembly 936 and further includes mounting features 924.4.8.2, such as threaded holes, to secure it in place.

The central base portion 924.4.4 is a reinforced area configured to provide a solid base for the actuator mount 930.2 of the coupling assembly 930 and serves as a transition from the forward platform portion 924.4 to the rear platform portion 924.6. The central base portion 924.4.4 may also contain additional mounting features for securing the heat transfer device 936.4. The rear platform portion 924.6 includes a reinforcement section 924.6.2 and a heel coupling section 924.6.4. The reinforcement section 924.6.2 is configured to include and support the rear support 930.6 of the coupling assembly. The heel coupling section 924.6.4 is configured to couple with both the roll limiter 924.8 and the heel coupler 928.6 of the interconnect assembly. The heel coupling section 924.6.4 may include a first set of mounting structures 924.6.4.2 to couple the roll limiter 924.8 and a second set of mounting structures 924.6.4.4 to couple the heel coupler 928.6. For example, the mounting structures 924.6.4.2, 924.6.4.4 may include mounting apertures, threaded inserts, and/or other coupling features to securely couple both the roll limiter 924.8 and the heel coupler 928.6 to the pedestal 924. The roll limiter 924.8 is configured to interface with the heel interface 886 of the talus 88 to limit the roll of the foot 92 about axis A₁₆.

ii. Coupling Assembly

Referring to FIGS. 27-28, the coupling assembly 930 includes an actuator mount 930.2, a forward coupling frame 930.8, and a rear support 930.6. The actuator mount 930.2 is configured to interface with and securely attach to the output portion 908 of the foot roll actuator (J16) 900. The rear support 930.6 extends from the actuator mount 930.2 and couples to the pedestal 924 with a calculated clearance from the talus housing 882, such that the foot 92 may rotate freely about the foot roll axis A₁₆ without mechanical interference. The talus housing 882 and the pedestal 924 are configured to interface such that the pedestal 924 rolls smoothly with respect to the talus 88 when driven by the output portion 908 of the foot roll actuator (J16) 900. The actuator mount 930.2 includes a mounting base 930.2.2 and a mounting

receptacle 930.2.4. The mounting base 930.2.2 is coupled to the central base portion 924.4.4 of the pedestal 924. The mounting receptacle 930.2.4 has a substantially circular shape and includes a flat mounting wall 930.2.4.2 and a circumferential collar wall 930.2.4.4 that extends rearward from the perimeter of the mounting wall 930.2.4.2. The mounting wall 930.2.4.2, having a front surface 930.2.4.2.2 and a rear surface 930.2.4.2.4, may further include a central opening 930.2.6 formed therethrough and a plurality of apertures 930.2.8 surrounding the central opening 930.2.6 in a bolt-circle pattern. The mounting receptacle 930.2.4 is configured to receive the output portion 908 of the foot roll actuator (J16) 900 and couple it securely to the mounting wall 930.2.4.2. For example, the output portion 908 of the foot roll actuator (J16) 900 may be received into the collar wall 930.2.4.4 for alignment and coupled to the mounting wall 930.2.4.2 by a plurality of fasteners that extend through the plurality of apertures 930.2.8.

The rear support 930.6 extends rearward from the mounting base 930.2.2 of the actuator mount 930.2. The rear support 930.6 may be configured to provide additional structural support to the actuator mount 930.2 and/or to increase the torsional stiffness of the pedestal 924. The rear support 930.6 may include left and right interior supports 930.6.2a, 930.6.2b and left and right exterior supports 930.6.4a, 930.6.4b that extend from the mounting base 930.2.2 to the heel coupling section 924.6.4 of the pedestal 924. For example, the left and right interior supports 930.6.2a, 930.6.2b may be spaced parallel to each other and to the first reference plane PFI. They are configured to allow a clearance between the interior supports 930.6.2a, 930.6.2b and the talus frame 884 such that the pedestal 924 may roll based on the movement of the foot roll actuator (J16) 900 without interference.

In various embodiments, the interior supports 930.6.2a, 930.6.2b may also define a protected wiring channel 930.6.2.4 through which wires or other electrical connections may be routed from the foot 92 to other components of the robot 1. For example, the first and second leads 936.2.2.2.2, 936.2.2.2.4 of the charging assembly 936 may be positioned within this wiring channel 930.6.2.4 and electrically coupled to a charging controller 888 and/or the main battery 202 of the robot 1. The left and right exterior supports 930.6.4a, 930.6.4b extend from an outer portion of the mounting base 930.2.2 rearward along the pedestal 924 to the heel coupling section 924.6.4. The left and right exterior supports 930.6.4a, 930.6.4b provide lateral support to the mounting base 930.2.2 and are configured with a sufficient clearance to allow the foot 92 to rotate with respect to the talus 88 without interference.

The forward coupling frame 930.8 extends forward from the front surface 930.2.4.2.2 of the actuator mount 930.2 to the toe coupling section 924.2 of the pedestal 924. The forward coupling frame 930.8 may include a biasing interface 930.4, a center support 930.8.2, and side supports 930.8.4. The biasing interface 930.4 is configured to receive the toc biasing device 934 and extends downward from the central opening 930.2.6 of the actuator mount 930.2 to the front coupling portion 924.2 of the pedestal 924. The center support 930.8.2 projects from an upper portion of the biasing interface 930.4 and the side supports 930.8.4 extend to the front coupling portion 924.2 along the sides of the biasing interface 930.4.

In the illustrative embodiment, the biasing interface 930.4 includes a hollow cylinder 930.4.2 with a device collar 930.4.4 on its proximal end and a limiting rim 930.4.6 on its distal end. The device collar 930.4.4 is coupled to the central opening 930.2.6 of the actuator mount 930.2 and includes an internally threaded opening that is communicatively coupled to the hollow interior of the cylinder 930.4.2. The biasing interface 930.4 is configured to receive the various components of the toe biasing device 934 within the hollow interior of the cylinder 930.4.2.

The coupling assembly 930 further includes bridge interconnect features 930.14 to couple each interconnect bridge 928.2.2 to the sides of the pedestal 924. The bridge interconnect features 930.14 include alignment projections 930.14.2, interface slots 930.14.4, and securement points 930.14.6. The securement points 930.14.6 may include a first securement point 930.14.6.2 positioned on the side support 930.8.4, a second securement point 930.14.6.4 positioned on the collar wall 930.2.4.4 of the actuator mount 930.2, and a third securement point 930.14.6.6 positioned in the rear platform section 924.6. The side frame sections 924.4.2.4 of the pedestal 924 include interface slots 930.14.4 formed therein and alignment projections 930.14.2 projecting laterally and configured to interface with the interconnect bridge 928.2.2. The alignment projections 930.14.2 are configured to be received into the alignment seats 928.2.2.2 and the interface slots 930.14.4 are configured to receive the locking projections 928.2.2.4 of the interconnect bridge 928.2.2. The interconnect bridge 928.2.2 is further secured to the pedestal 924 at the securement points 930.14.6.

iii. Toe Structure

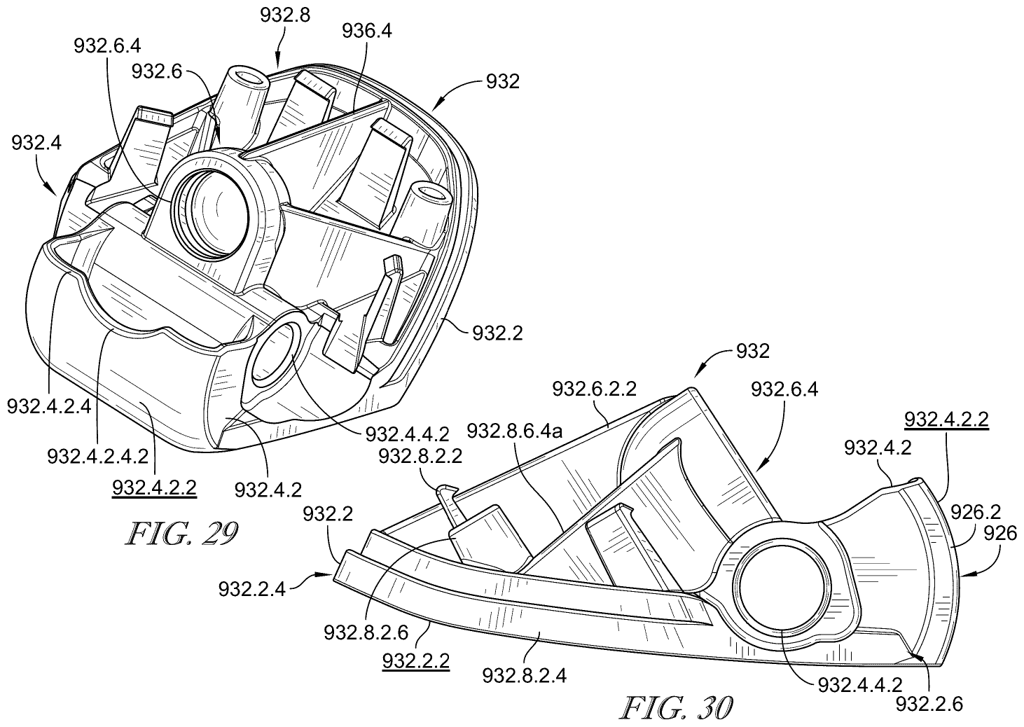

Referring to FIGS. 29-30, the single toe structure 932 is configured to be coupled with the pedestal 924 at the forward toe coupling section 924.2. The toe structure 932 includes a main base 932.2, a frame coupling portion 932.4, a device coupling portion 932.6, and a cover coupling portion 932.8. The toe structure 932 is hingedly coupled to the pedestal 924 at a hinge receiver 932.4.4.2 of the frame coupling portion 932.4. This coupling defines a toc pivot axis ATP about which the toc structure 932 may pivot about, when said foot moves from an initial position to a flexed position. To cause the foot to move from its initial position to the flexed position, the magnitude of a compressive force F_{C} must be greater than the magnitude of the opposed biasing force F_{B}. In other words, the application of the Fe on said toe structure 932 (e.g., during walking) load causes the magnitude of the F_{C} to be greater than the magnitude of the F_{B}. This in turn causes the toc structure 932 to move towards pedestal 924, as the foot moves from said initial position to the flexed position.

The device coupling portion 932.6, located forward of the hinge receiver 932.4.4.2, is configured to interface with the passive toe biasing device 934 that is coupled to the pedestal 924. This device includes a preloaded mechanism to passively return the toe structure to its initial position from a flexed position. This configuration allows for a more fluid and natural movement of the foot 92 when robot 1 is walking. It also enables the robot 1 to increase the extent of the sole that remains in contact with the support surface during the push-off phase of a step, improving traction and stability In other words, whereas a rigid, non-bending toc would concentrate contact force onto a single edge during locomotion, the disclosed foot 92 with its pivoting toc structure 932 maintains a broad contact patch between its sole and the support surface for a longer duration. The toc structure 932 is further configured with cover coupling means 932.8.2, such as integrated clips or mounting points, to attach the foot cover 938 to the toc structure 932, which helps to enclose the base assembly 920.2.

As best shown in FIG. 30, the base 932.2 extends from a rounded front portion 932.2.2 to a rear interface edge 932.2.6 located rearward of the hinge receiver 932.4.4.2. The base 932.2 has a defined thickness and includes a front shelf 932.2.4 further defined by an inset border rim 932.2.4.2 that extends from the front portion 932.2.2 to the hinge receiver 932.4.4.2. The extent of the base 932.2 up to the inset border rim 932.2.4.2 is configured to be received within a corresponding front undercut groove 926.4.2.2 of the front rim portion 926.4.2 of the sole 926. The base 932.2 tapers in width as it approaches the toe coupling section 924.2 and includes contours to allow for clearance and proper coupling with the pedestal 924 at the hinge receiver 932.4.4.2. The base 932.2 includes a curved lower surface 932.2.12 that gradually increases in its radius of curvature from the rear interface edge 932.2.6 to the rounded front portion 932.2.2, facilitating a smooth rolling motion during walking. The curved lower surface 932.2.12 is also configured to receive a toc shield 936.8 of the charging assembly 936, which may be adhered to the lower surface 932.2.12 and is subsequently received within the sole 926.

The frame coupling portion 932.4 of the toe structure 932 includes the hinge receiver 932.4.4.2 and a base interface 932.4.2. The base interface 932.4.2 is positioned rearward of the hinge receiver 932.4.4.2 and includes an arcuate interface wall 932.4.2.2 with a facing surface 932.4.2.6 that is configured to move with respect to the coupling wall 924.2.4 of the pedestal 924. As best shown in FIG. 29, the frame coupling portion 932.4 has a width that is less than the width of the widest portion of the base 932.2 that is forward of the hinge receiver 932.4.4.2. The arcuate interface wall 932.4.2.2 includes an edge 932.4.2.4 with a curved center notch 932.4.2.4.2, which is configured to abut an extent of the biasing interface 930.4 of the pedestal 924. As best illustrated in FIGS. 33A-33B, the edge 932.4.2.4 of the arcuate interface wall 932.4.2.2 is configured to cooperate with a limit projection 924.2.4.2.2 on the coupling wall 924.2.4 of the pedestal 924. This interaction acts as a toe pitch stop to limit the downward rotation of the toe structure 932 and define its initial position.

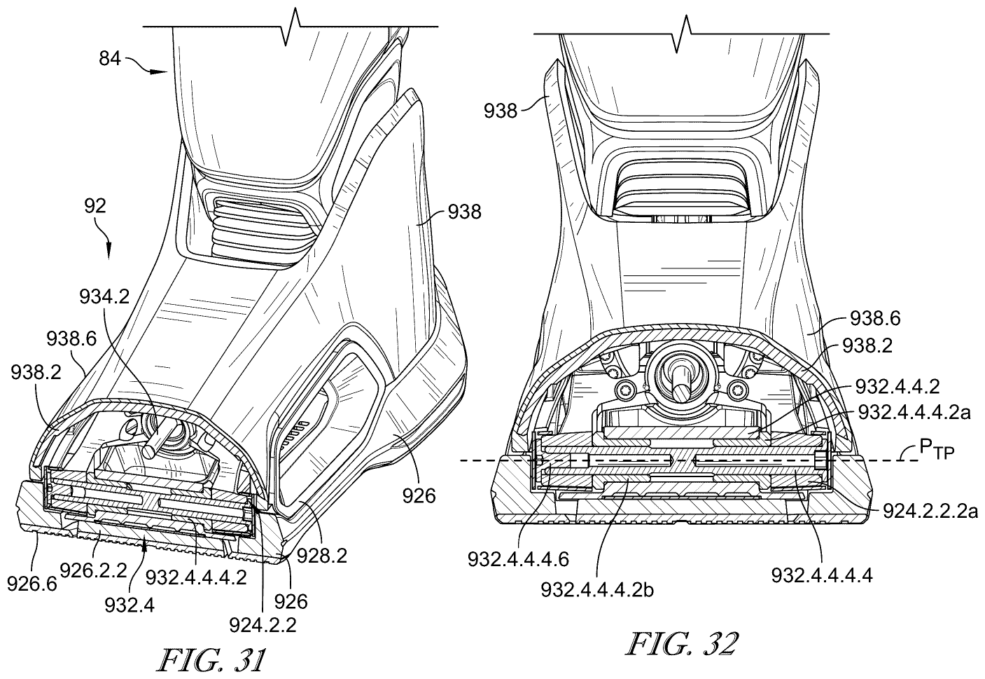

As best illustrated in FIGS. 31-32, the toc structure 932 is coupled to the pedestal 924 by frame coupling means 932.4.4, which defines the toe pivot axis ATP. In the illustrative embodiment, a hinge coupler 932.4.4.4 is received through the joint coupling portions 924.2.2.2.2 of the pedestal 924 and the hinge receiver 932.4.4.2 of the toc structure 932. The hinge coupler 932.4.4.4 includes a pair of bushings 932.4.4.4.2, a shaft 932.4.4.4.4, and a shaft fastener 932.4.4.4.6. The pair of bushings 932.4.4.4.2, which may be made of a low-friction material like bronze or a polymer, are inserted into the hinge receiver 932.4.4.2 on the left and right sides to provide a durable interface with the interior edges of the joint coupling portions 924.2.2.2.2. The shaft 932.4.4.4.4 is received through an opening 924.2.2.4 of one joint coupling portion 924.2.2.2.2, passes through the bushings 932.4.4.4.2 and hinge receiver 932.4.4.2 of the toc structure 932, and is secured through the opening 924.2.2.4 of the opposing joint coupling portion 924.2.2.2.2 by the shaft fastener 932.4.4.4.6. In other embodiments, other means of coupling, such as integrated bearing assemblies, may be used to couple the toe structure 932 to the pedestal 924.

Turning to FIGS. 29-30, the device coupling portion 932.6 includes a toe frame support 932.6.2 and a rod socket 932.6.4. The rod socket 932.6.4 includes a curved surface 932.6.4.2.2 formed in a socket frame 932.6.4.6 that projects from the hinge receiver 932.4.4.2. The curved surface 932.6.4.2.2 may be substantially hemispherical and is configured to receive the distal, second end 934.2.2 of the positioning rod 934.2 of the toc biasing device 934. The toc frame support 932.6.2 includes a main support 932.6.2.2 and side supports 932.6.2.4 that extend from the socket frame 932.6.4.6 to the base 932.2. The toe frame support 932.6.2 distributes the load from both the toc biasing device 934 acting on the toe structure 932 and the ground or other support surface acting on the base 932.2, causing the toc structure 932 to pivot. The cover coupling portion 932.8 includes cover coupling means 932.8.2 that are secured to the toc structure 932. In the illustrative embodiment, the cover coupling means 932.8.2 are formed integrally with the toc structure 932 and include front locking projections 932.8.2.2, side locking projections 932.8.2.4, and alignment receptacles 932.8.2.6. These cover coupling means 932.8.2 are configured to interface with the front locking trim 938.4.4 of the foot cover 938 to securely attach it and enclose the base assembly 920.2.

b. Toe Biasing Device

Referring to FIGS. 8, 22, 23, 33, and 34, the toc biasing device 934 is received within the biasing interface 930.4 of the coupling assembly 930 of the foot frame 922. It extends from the pedestal to interface with the toe structure 932 at the rod socket 932.6.4. The toe biasing device 934 is a passive biasing device, implemented as a linear compression device, that is preloaded to a specific force. This force passively returns the toe structure 932 from a flexed position back to the initial position. As described above, when a compressive force F_{C} from ground contact is applied to the toe structure 932 in an amount that is greater than at least a portion of the biasing force F_{B}, the toe structure 932 pivots relative to the pedestal 924 about the toc pivot axis ATP. In the illustrative embodiment, the toc biasing device 934 includes a positioning rod 934.2, a plunger 934.4, a compression spring 934.6, and a bias force adjustment mechanism 934.8. The spring 934.6 is configured to resist movement of the front portion of the sole relative to the rear portion of the sole by applying a restorative force through the plunger and positioning rod. The toe biasing device 934 is received within the biasing interface 930.4 through the central opening 930.2.6 of the actuator mount 930.2 and into the hollow interior of the cylinder 930.4.2. The plunger 934.4 is substantially cylindrical and includes a socket 934.4.2 on one end and may have a projection 934.4.4 on the opposite end to help center the spring. The positioning rod 934.2 has: (i) a first end 934.2.4 with a first curvilinear surface that is configured to interface with the plunger socket 934.4.2, wherein this first end 934.2.4 is positioned within an extent of the pedestal 924, and (ii) a second end 934.2.2 with a second curvilinear surface that is configured to interface with the rod socket 932.6.4, wherein this second end 934.2.2 is positioned within an extent of the toe structure 932.

In the illustrative embodiment, the positioning rod 934.2 is received into the hollow interior of the cylinder 930.4.2 of the biasing interface 930.4 through the central opening 930.2.6 of the actuator mount 930.2, and is allowed to pass through the distal limiting rim 930.4.6 to be received in the rod socket 932.6.4 of the toe structure 932. The overall length of the positioning rod 934.2 is greater than the distance between the rod socket 932.6.4 and the limiting rim 930.4.6, such that an extent of the positioning rod 934.2 always remains within the biasing interface 930.4 throughout its range of motion. The positioning rod 934.2 is held in place by the toc structure 932 because the downward movement of the toe structure is mechanically limited by the edge 932.4.2.4 of the frame coupling portion 932.4 abutting the limit projection 924.2.4.2.2 of the pedestal 924. The limiting rim 930.4.6 on the distal end of the biasing interface 930.4 has an opening 930.4.6.2 that is configured to allow the positioning rod 934.2 to pass through but is smaller than the plunger 934.4, thereby stopping its movement. In other words, the diameter of the limiting rim opening 930.4.6.2 is greater than the diameter of the ends 934.2.2, 934.2.4 of the positioning rod 934.2 but is less than the outer diameter of the plunger 934.4.

Next, the plunger 934.4 is received into the hollow interior of the cylinder 930.4.2, with the plunger socket 934.4.2 interfacing with the first proximal end 934.2.4 of the positioning rod 934.2. The spring 934.6 is received after the plunger 934.4 and may be partially received around the projection 934.4.4 of the plunger 934.4 if present. In some embodiments, the projection 934.4.4 is omitted and the spring 934.6 may abut a flat surface of the plunger 934.4. Next, the bias force adjustment mechanism 934.8 is received into the hollow interior of the cylinder 930.4.2. It is used to compress and hold the spring 934.6 against the plunger 934.4, which in turn applies a continuous biasing force to hold the toe structure 932 in its initial position. The bias force adjustment mechanism 934.8 includes an externally threaded portion 934.8.2 that interfaces with the internally threaded opening of the device collar 930.4.4 of the biasing interface 930.4. It also includes an internal channel 934.8.4 that allows the passage of air to escape the pedestal when the toe biasing device 934 is compressed, preventing pneumatic damping effects. Further, the threaded interface between the bias force adjustment mechanism 934.8 and the device collar 930.4.4 is configured to allow for precise adjustment of the compression applied to preload the spring 934.6. This allows an operator to control the magnitude of the biasing force that is applied to bias the toe structure toward the initial position, enabling tuning for different payloads or walking surfaces.

c. Charging Assembly

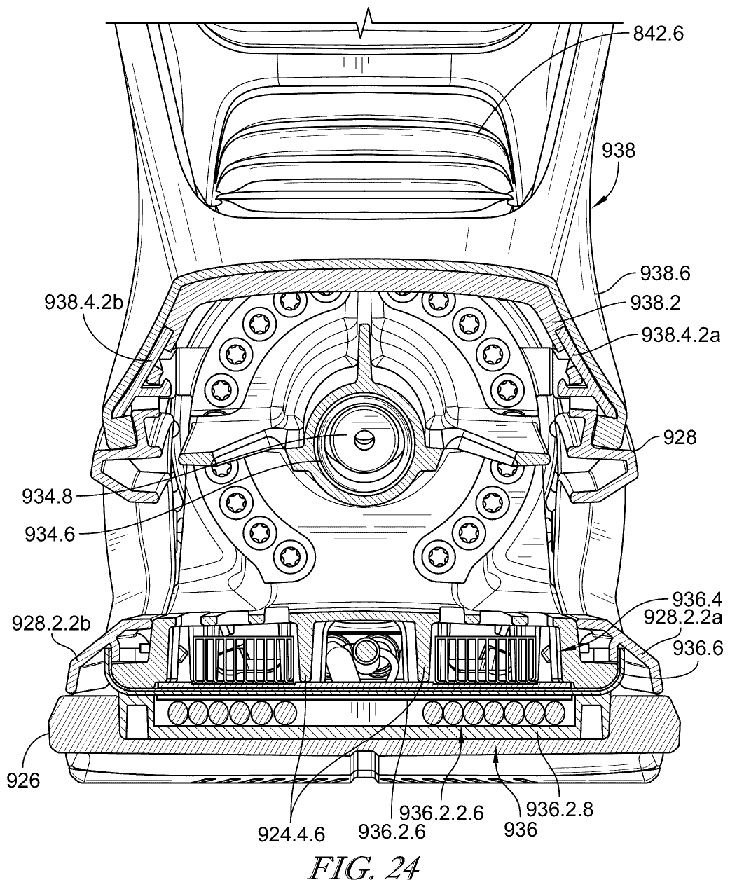

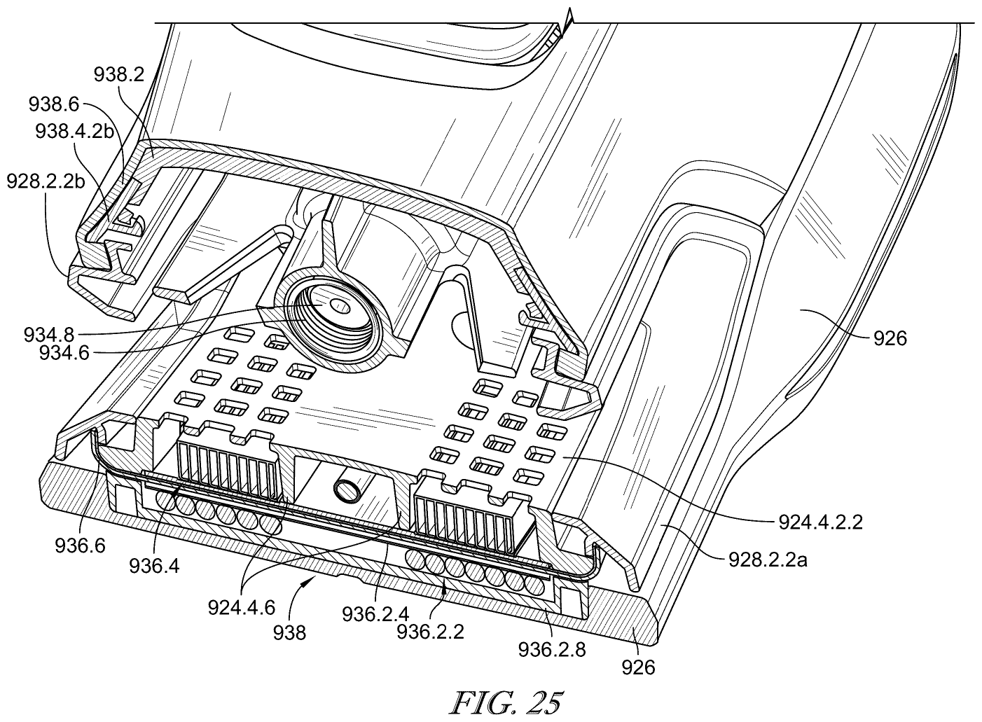

Referring to FIGS. 24, 25, and 33-35, the wireless charging assembly 936 may include a receiving coil module 936.2, a heat transfer device 936.4, a foot shield 936.6, and a toc shield 936.8. This assembly is coupled to a lower extent of the pedestal 924. The receiving coil module 936.2 may include a receiving coil 936.2.2, a coil shield 936.2.6, and a module base 936.2.8. The heat transfer device 936.4 is configured to be received in the pedestal 924 and coupled on the second side 924.12, positioned above the receiving coil. The foot shield 936.6 is positioned between the pedestal 924 and the receiving coil module 936.2. The foot shield 936.6 is shaped to substantially cover the second side 924.12 of the pedestal 924, including the heat transfer device 936.4. A toc shield 936.8 may be coupled to the lower surface 932.2.12 of the toc structure 932.

The receiving coil 936.2.2 includes a wire 936.2.2.2 that may be wound to include a number of turns to form a planar coiled wire layer 936.2.2.6. It also has a first end lead 936.2.2.2.2 and a second end lead 936.2.2.2.4. For example, the wire 936.2.2.2 may be multi-stranded Litz wire to reduce skin effect losses at high frequencies, and the number of turns may be between 3 and 20, preferably between 5 and 10. The coiled wire layer 936.2.2.6 may have a substantially oval or oblong shape, dimensioned to be less than the perimeter of the pedestal 924 of the foot frame 922. The first end lead 936.2.2.2.2 may extend from an interior portion of the coiled wire layer 936.2.2.6 and the second end lead 936.2.2.2.4 may extend from an exterior portion of the coiled wire layer 936.2.2.6. The first and second end leads 936.2.2.2.2, 936.2.2.2.4 may include insulation sleeves 936.2.2.4.2, 936.2.2.4.4 to reduce electromagnetic interference with other components. The coil shield 936.2.6 has a substantially oval or oblong shape configured to overlay the shape of the receiving coil 936.2.2. This shield partially surrounds the receiving coil 936.2.2 and is positioned between said receiving coil and the pedestal 924.

The coil shield 936.2.6 is substantially planar and may include one or more layers of shielding material. The coil shield 936.2.6 may include a first layer 936.2.6.2 configured to shield against electromagnetic interference (EMI) by containing the magnetic field, and a second layer 936.2.6.4 configured to insulate and resist heat buildup, where the second layer 936.2.6.4 may be positioned between the first layer 936.2.6.2 and the receiving coil 936.2.2. For example, the first layer 936.2.6.2 may be a nanocrystalline material, which provides high magnetic permeability for effective shielding. the second layer 936.2.6.4 may include a polyimide film, such as Kapton® or another high-performance film, for thermal and electrical insulation. The coil shield 936.2.6 includes a shield opening 936.2.6.6 and an edge notch 936.2.6.8 configured to allow passage of the first and second end leads 936.2.2.2.2, 936.2.2.2.4 of the receiving coil 936.2.2 through the coil shield 936.2.6. The shield opening 936.2.6.6 is configured to receive the first end lead 936.2.2.2.2 therethrough. The edge notch 936.2.6.8 is positioned to receive the second end lead 936.2.2.2.4 therethrough. In some embodiments, the coil shield 936.2.6 may further include a slit or narrow gap opening that extends between the shield opening 936.2.6.6 and the edge notch 936.2.6.8. This is configured to reduce the eddy current losses that could otherwise be induced in the shield material by the current flowing through the first end lead 936.2.2.2.2. The coil shield 936.2.6 may be adhered to the planar coiled wire layer 936.2.2.6, with the first and second end leads 936.2.2.2.2, 936.2.2.2.4 extending through the shield opening 936.2.6.6 and the edge notch 936.2.6.8, respectively.

The module base 936.2.8 has a shape substantially similar to the pedestal 924. For example, the module base 936.2.8 is dimensioned to have a perimeter that is substantially the same as, or slightly less than, the perimeter of the pedestal 924, such that the charging module 936.2 may be coupled to the pedestal 924 and be received within the main interface surface 926.2.4.2 of the sole 926. The module base 936.2.8 includes a first side 936.2.8.2 configured to face the pedestal 924 and a second side 936.2.8.4 configured to couple with the sole 926. The receiving coil 936.2.2 is thus positioned between the coil shield 936.2.6 and the sole 926. The module base 936.2.8 may have a thickness (t_{CM}) between the first side 936.2.8.2 and the second side 936.2.8.4 that is greater than the thickness (t_{WL}) of the planar coiled wire layer 936.2.2.6. A coil receptacle 936.2.8.2.2 is formed in the first side 936.2.8.2 of the module base 936.2.8 and is shaped to receive the coiled wire layer 936.2.2.6 of the receiving coil 936.2.2, with the second end lead 936.2.2.2.4 positioned toward the front end of the module base 936.2.8. The coil receptacle 936.2.8.2.2 may include an oblong recess 936.2.8.2.2.2 dimensioned to substantially match the depth, general shape, and total width based on the number of turns of the planar coiled wire layer 936.2.2.6. The coil receptacle 936.2.8.2.2 also includes an interior portion 936.2.8.2.2.4 having the same thickness (t_{CM}) as the module base 936.2.8, where the coiled wire layer 936.2.2.6 is received into the oblong recess 936.2.8.2.2.2 that surrounds this interior portion 936.2.8.2.2.4. The coil shield 936.2.6 substantially encloses the coiled wire layer 936.2.2.6 within the module base 936.2.8. The module base 936.2.8 may be formed of a thermoplastic material. For example, the module base 936.2.8 may include a polybutylene terephthalate (PBT) and fiberglass (FG) substrate for structural integrity and an ethylene vinyl acetate (EVA) surface material for shock absorption.

The foot shield 936.6 is configured to substantially cover the second side 924.12 of the pedestal 924, including at least a portion of the joint coupling portions 924.2.2.2.2. Similar to the coil shield 936.2.6, it may include one or more shielding layers to protect internal electronics from EMI generated by the charging process. For example, a first foot shield layer 936.6.6.2 may be configured to shield against electromagnetic interference (EMI) and a second foot shield layer 936.6.6.4 may be configured to insulate or protect the first layer. The first foot shield layer 936.6.6.2 may be a nanocrystalline material and the second layer 936.2.6.4 may include a polymer or plastic, such as polyethylene terephthalate (PET). Further, the foot shield 936.6 includes first and second shield openings 936.6.6.6, 936.6.6.8 configured to allow passage of the first and second end leads 936.2.2.2.2, 936.2.2.2.4 of the receiving coil 936.2.2. Similarly, the toc shield 936.8 may comprise the same layers as the foot shield 936.6 and be coupled to the lower surface 932.2.12 of the toc structure 932.

The heat transfer device 936.4 is configured to be received into the compartment 924.4.8 formed in the second side 924.12 of the pedestal 924. The receiving coil module 936.2 is positioned below the heat transfer device 936.4 and is thermally coupled to said heat transfer device 936.4, for example, through the conductive material of the pedestal itself. The heat transfer device 936.4 includes a base plate 936.4.2 and one or more heat transfer units 936.4.4a, 936.4.4b, such as heat pipes or vapor chambers, coupled to the base plate 936.4.2. The base plate 936.4.2 has a first side 936.4.10 and a second side 936.4.12 and is dimensioned to fit within and substantially cover the compartment 924.4.8 on the second side 924.12 of the foot pedestal 924. The base plate 936.4.2 includes first and second plate openings 936.4.2.6, 936.4.2.8 configured to allow passage of the first and second end leads 936.2.2.2.2, 936.2.2.2.4 of the receiving coil 936.2.2 into the pedestal 924. The base plate includes first and second plate openings 936.4.2.6, 936.4.2.8 that are centered, and the heat transfer units 936.4.4a, 936.4.4b are coupled to the first side 936.4.10 of the base plate 936.4.2 on the left and right sides of the first and second plate openings 936.4.2.6, 936.4.2.8. In the illustrative embodiment, the first plate opening 936.4.2.6 is set back from the front edge of the base plate 936.4.2 and the second plate opening 936.4.2.8 is formed as a notch in the rear edge of the base plate 936.4.2. In some embodiments, the second plate opening 936.4.2.8 is expanded to include the first plate opening 936.4.2.6 as a single elongated slot.

The heat transfer device 936.4 is received into the compartment 924.4.8 formed in the second side 924.12 of the pedestal 924 and secured thereto. Openings are formed in an extent of the pedestal 924, such as the grate section 924.4.2.2, to allow for air, which may be forced or drawn from above the foot through the shin and talus, to be forced into contact with said heat transfer device 936.4 for active or passive cooling. The heat transfer units 936.4.4a, 936.4.4b are spaced apart and configured to be received on the left and right sides of the pair of central supports 924.4.6 that span the length of the forward platform section 924.4. the first and second plate openings 936.4.2.6, 936.4.2.8 align with the wiring channel formed between the pair of central supports 924.4.6 such that the first and second end leads 936.2.2.2.2, 936.2.2.2.4 of the coil module 936.2 may be routed to the wiring channel of the rear platform portion 924.6 and subsequently to other parts of the robot 1. In particular, the first and second end leads 936.2.2.2.2, 936.2.2.2.4 extend through the coil shield 936.2.6 and the foot shield 936.6 before passing through the first and second plate openings 936.4.2.6, 936.4.2.8.

i. Wireless Charging

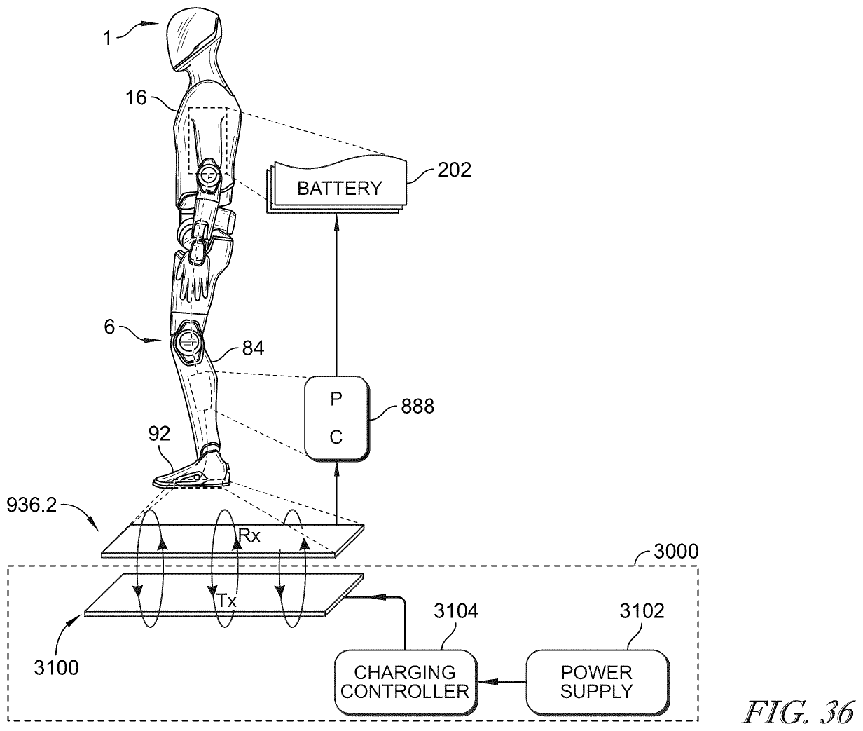

Referring to FIG. 36, the charging assembly 936 in each foot 92 of the robot 1 is configured such that the receiving coil module 936.2 may electrically couple with a wireless charging system 3000. For example, the illustrative wireless charging system 3000 may include a power supply 3102, a charging controller 3104, and a wireless power transmitter pad 3100. The wireless power transmitter pad 3100 is configured such that the robot I can stand on the transmitter pad 3100 and wirelessly couple to charge one or more batteries within the robot 1. The wireless power transmitter pad 3100 may be configured with a pair of transmitting coil modules housed within it. These are spaced such that when the robot 1 is standing in a neutral state, it may substantially align the receiving coils 936.2 of each foot 92 with the respective transmitting coils of the pad 3100 for effective inductive power transfer.

For example, the robot I may detect a low power level of its battery pack 202 while performing a task, complete or safely interrupt the task, and then autonomously navigate to and stand on the wireless power transmitter pad 3100 for charging. In the illustrative embodiment, the battery pack 202 is housed in the torso 16 of the robot 1. The receiving coil module 936.2 in each foot 92 is electrically coupled to the battery and is configured to charge the battery pack 202. The robot I may include a charging controller 888 individually coupled to each receiving coil module 936.2. The charging controller 888 is further electrically coupled to the battery pack 202 and/or a power distribution system, as well as to a whole body controller 1550 and/or other controllers 1600 contained in the robot 1. For example, a charging controller 888 may include circuitry for operational control of the respective receiving coil modules 936.2 and may be positioned in each respective shin 84, close to the foot 92 containing the receiving coil module 936.2, to minimize line losses.

Including a receiving coil module 936.2 in each foot 92 provides for potentially faster charging and for redundancy in the charging system. For example, if one receiving coil module 936.2 is not functioning properly, the robot 1 may communicate a need for maintenance to an operator, while still being able to slowly charge the battery pack 202 using the other operational receiving coil module 936.2. This change in power distribution, along with continuous monitoring and communication, may be managed by the individual charging controller 888 and/or other controllers 1600 contained in the robot 1.

### 2. Foot Enclosure

As discussed above, the foot enclosure 920.4 includes (i) a sole 926, (ii) an interconnect assembly 928, and (iii) a foot cover 938. The sole 926 is coupled to the foot frame 922, substantially enclosing the charging assembly 936, and is configured to deform with the movement of the toe structure 932. The interconnect assembly 928 is coupled to the foot frame 922 and is configured to provide secure attachment points for the foot cover 938. In particular, the foot cover 938 includes a carrier 938.2, a locking trim assembly 938.4, and a textile layer 938.6, where the locking trim assembly 938.4 is configured to attach to the foot frame 922 by the cover coupling means 932.8.2 of the toe structure 932, by interconnect bridges 928.2 at the sides of the pedestal 924, and by a heel coupler 928.6 at the rear. The foot cover 938 is shaped to resemble a shoe upper and cooperates with the sole 926 to substantially enclose the base assembly 920.2 which is coupled to the talus 88.

a. Sole

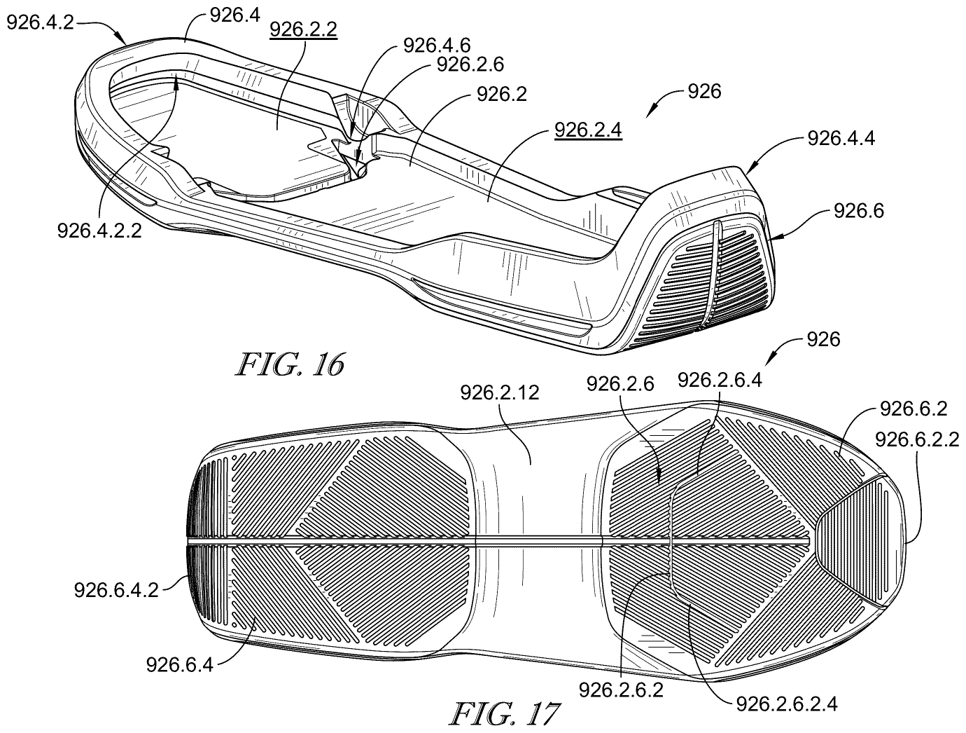

Referring to FIGS. 16-18, the sole 926 is configured to couple to the foot frame 922, substantially enclosing the charging assembly 936 that is coupled to the pedestal 924 and also enclosing a base portion of the toe structure 932. The sole 926 includes a sole base 926.2, a perimeter rim 926.4, and an outsole layer 926.6. The sole base 926.2 includes a front portion 926.2.2 with a front interface surface 926.2.2.2 that is configured to receive and contact the lower surface 932.2.12 of the toe structure 932. In various embodiments, the lower surface 932.2.12 of the toc structure 932 may include the toe shield 936.8, which is coupled to the toe structure 932. The sole base 926.2 includes a rear portion 926.2.4 with a rear interface surface 926.2.4.2 that is configured to receive and contact the lower surface 936.2.8.4.2 of the charging module 936.2. The sole base 926.2 also includes a lower surface 926.2.12 that is configured to couple with an outsole layer 926.6, which is the layer configured to make contact with the ground or support surface PG.

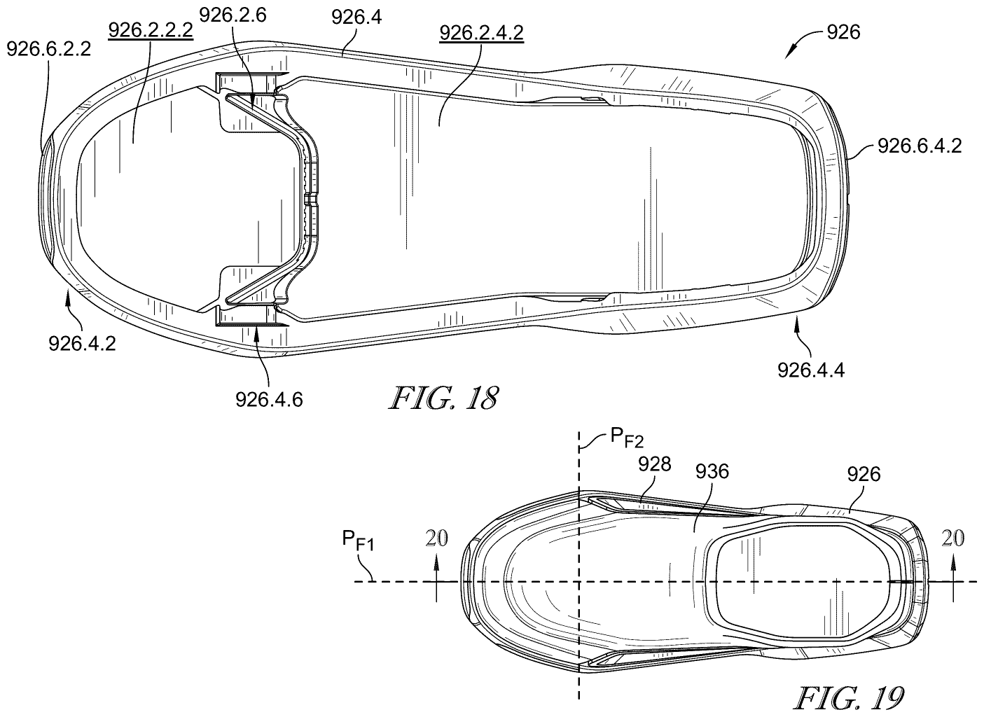

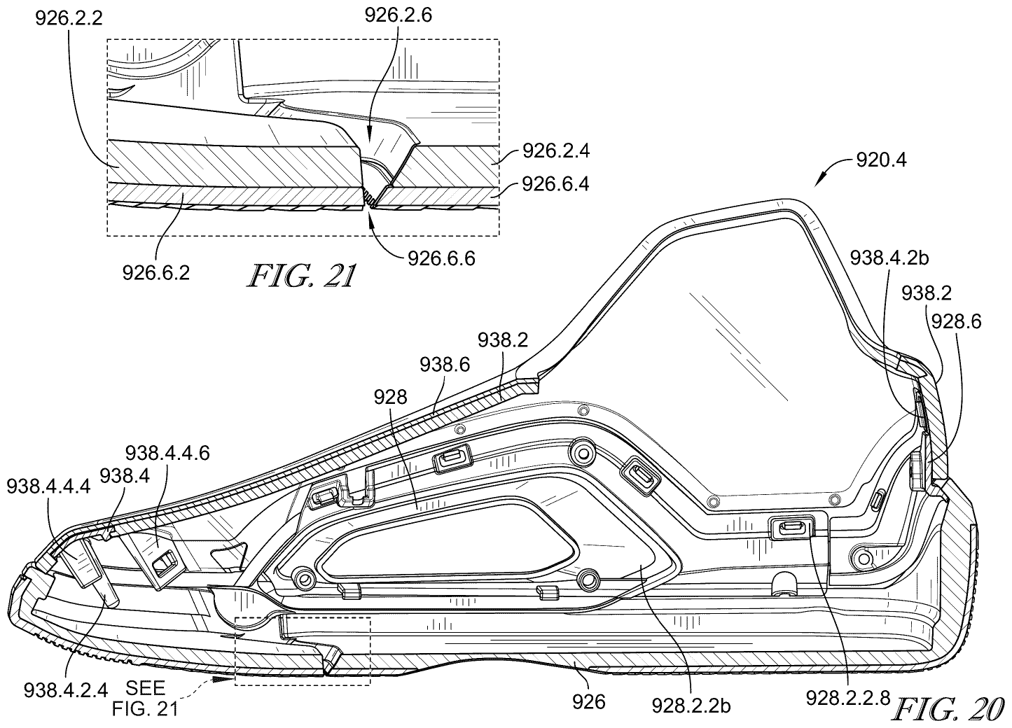

The sole base 926.2 includes a front portion 926.2.2 and a rear portion 926.2.4, defined in part by a separation slit formed through the sole in a coupling portion 926.2.6 positioned between the front and rear portions. The separation slit 926.2.6 is shaped to correspond with an extent of the base 932.2 of the frame coupling portion 932.4 of the toc structure 932. The separation slit 926.2.6 does not extend across the full width of the sole 926, may have a curvilinear shape and is symmetrical about the first reference plane PFI. This slit is configured to allow relative movement between the front portion and the rear portion of the sole, such as when the foot moves from an initial position to a flexed position during walking. As illustrated in FIG. 18, the separation slit 926.2.6 may have a flattened U-shape when viewed from the top. It includes a central slit section 926.2.6.2.2 is substantially linear and side slit sections 926.2.6.2.4 extend outward from the central slit section 926.2.6.2.2. An angle is formed between an extent of the left and right side slit sections and the central slit section. These side slit sections extend at an angle to meet the rim 926.4, without extending into the rim itself. The outsole layer 926.6 that is coupled to the lower surface 926.2.12 of the sole base 926.2 may also include a corresponding slit 926.6.2.6. The separation slit 926.2.6.2 may include a defined gap 926.2.6.2.8 between a front edge 926.2.4.6 of the rear portion 926.2.4 and the rear edge 926.2.2.6 of the front portion 926.2.2. As illustrated in FIG. 21, the gap may increase in its width profile from a narrow slit 926.6.2.6 in the outsole layer 926.6 up to the front and rear interface surfaces 926.2.2.2, 926.2.4.2.

The rim 926.4 extends around the perimeter of the sole base 926.2 and includes a front rim portion 926.4.2, a rear rim portion 926.4.4, a hinge interface 926.4.6, and a side rim portion 926.4.8 that extends between the hinge interface 926.4.6 and the rear rim portion 926.4.4. The front rim portion 926.4.2 includes a front undercut groove 926.4.2.2 that is configured to couple with at least an edge extent of the base 932.2 of the toc structure 932. The hinge interface 926.4.6 includes a contoured portion 926.4.6.2 that is configured to receive the joint coupling portions 924.2.2.2.2 of the forked projections 924.2.2.2 of the pedestal 924. The side rim portions 926.4.8 are configured to abut the interconnect bridges 928.2 that are coupled to each side of the pedestal 924. The rear rim portion 926.4.4 includes a rear undercut groove 926.2.8.2 that is configured to receive and couple with at least an edge extent of the charging module 936.2, the foot shield 936.6, and the rear platform portion 924.6. The rear rim portion 926.4.4 includes a heel extension 926.4.4.2 where the rear undercut groove 926.2.8.2 continues and interfaces with at least an extent of the heel coupler 928.6 that couples a rear extent of the foot cover 938 to the foot 92.

Referring to FIGS. 16-17, the outsole layer 926.6 may include a front portion 926.6.2 and a rear portion 926.6.4 that are coupled to the lower surface 926.2.12 of the sole base 926.2. In the illustrated embodiment, the outsole layer 926.6 may include a distinct front portion 926.6.2 and rear portion 926.6.4. The front portion 926.6.2 extends from a toe kick portion 926.6.2.2 at the front of the shoe 92, substantially covers the lower surface 926.2.12.2 of the front portion 926.2.2 of the sole base 926, and may extend beyond the slit 926.6.2.6 to a mid-sole portion 926.2.4.2 that is not covered. The rear portion 926.6.4 extends from the uncovered mid-sole portion 926.2.4.2 to a heel portion 926.6.4.2. In other embodiments, the outsole layer 926.6 may be a continuous layer from front to back. The outsole layer 926.6 may further include a tread pattern 926.6.6 to provide better traction or grip with the floor or ground.

b. Cover Interconnect Assembly

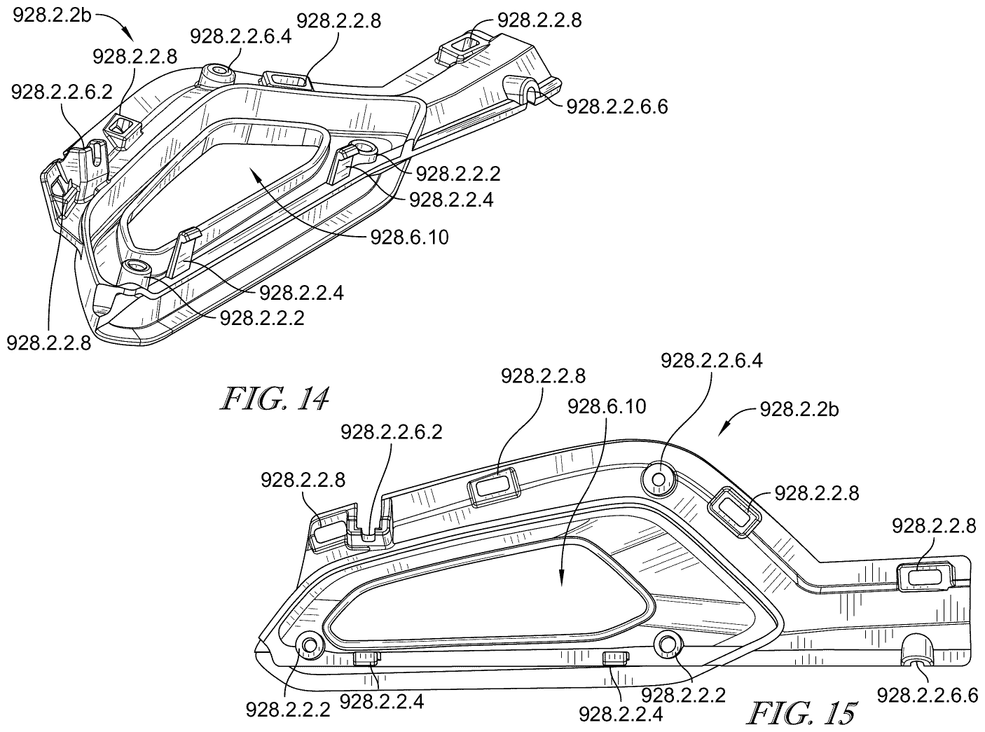

Referring to FIGS. 8, 13-15, and 20, the interconnect assembly 928 is mechanically secured to the pedestal 924 and includes a pair of interconnect bridges 928.2 and a heel coupler 928.6. The heel coupler 928.6 and the interconnect bridges 928.2, together with the frame coupling means 932.4.4 of the toe structure 932, are configured to couple with the locking trim assembly 938.4 of the foot cover 938, in order to securely attach the foot cover 938 to the foot frame 922. In the illustrative embodiment, the frame coupling means 932.4.4 of the toe structure 932 are formed in one piece with the toe structure 932. In other embodiments, the frame coupling means 932.4.4 may include one or more interconnect structures that are separately secured to the toc structure 932.

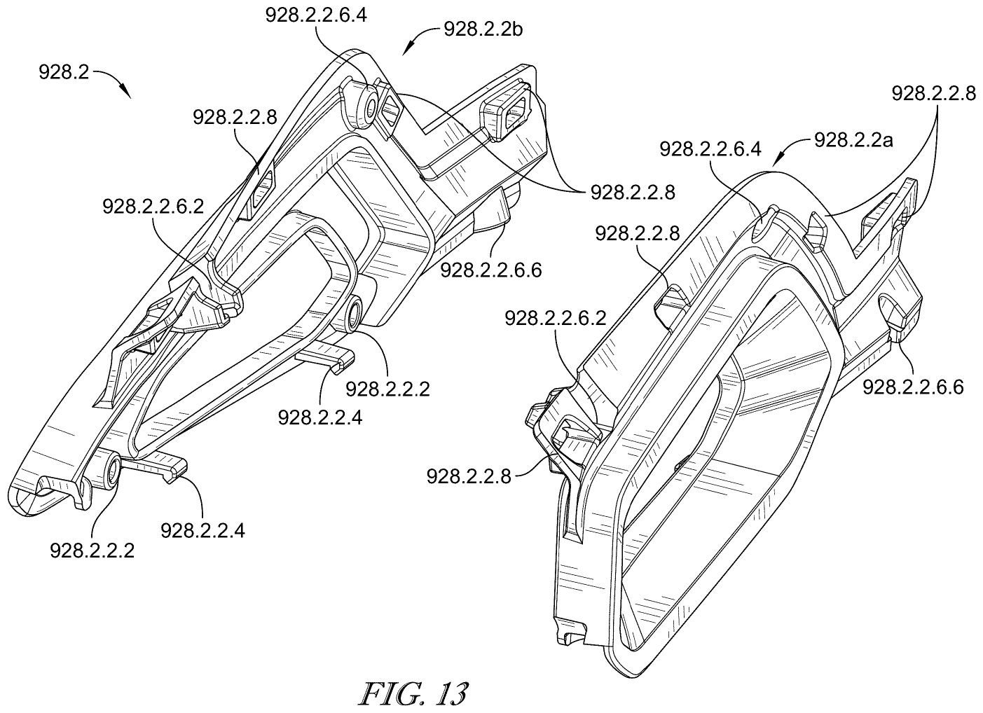

The pair of interconnect bridges 928.2 include individual left and right interconnect bridges 928.2.2a, 928.2.2b that are secured to the respective left and right sides of the pedestal 924 along the forward platform section 924.4. As shown in FIG. 13, the left and right interconnect bridges 928.2.2a, 928.2.2b include substantially similar features that mirror each other. Each interconnect bridge 928.2.2 includes alignment seats 928.2.2.2, locking projections 928.2.2.4, securement points 928.2.2.6, and trim attachment receptacles 928.2.2.8. Each interconnect bridge 928.2.2 is coupled to a respective side of the foot frame 922. In particular, the alignment seats 928.2.2.2 receive the alignment projections 930.14.2 that are positioned on the side frame sections 924.4.2.4 of the pedestal 924, and the locking projections 928.2.2.4 arc received into the interface slots 930.14.4. The interconnect bridge 928.2.2 is further secured to the pedestal 924 at the securement points 930.14.6. For example, the first, second, and third securement points 928.2.2.6.2, 928.2.2.6.4, 928.2.2.6.6 of the interconnect bridge 928.2 arc configured to align with the first, second, and third securement points 930.14.6.2, 930.14.6.4, 930.14.6.6 of the foot frame 922. The trim attachment receptacles 928.2.2.8 are configured to receive the side locking projections 938.4.2.2 of the foot cover 938 locking trim 938.4.2.

Each interconnect bridge 928.2.2 further includes an opening 928.6.10 formed therethrough, which is configured to allow airflow through the foot 92. The openings 928.6.10, together with the open space between the grate section 924.4.2.2 and the forward coupling frame 930.8, form a tunnel 924.4.10 that provides a cooling effect. Air is configured to be drawn into a shin and forced out of the opening in said interconnect assembly for thermal management. For example, the cooling may be passive, with heat radiating from the heat transfer device 936.4, passing through the grate section 924.4.2.2, and exiting through the openings 928.6.10. In another example, the robot 1 may further include one or more active cooling or ventilation devices. For example, a fan located in the shin 84, which delivers a forced airflow through the shin 84 to the foot 92 and out through the grate section 924.4.2.2 and the tunnel 924.4.10.

The heel coupler 928.6 is coupled to the pedestal 924 at the rear platform portion 924.6, rearward of the roll limiter 924.8 of the foot 92. Similar to the interconnect bridges 928.2.2, the heel coupler 928.6 includes trim attachment receptacles 928.6.8 that are configured to receive the rear locking projections 938.4.2.4 of the foot cover 938 locking trim 938.4.2.

c. Foot Cover

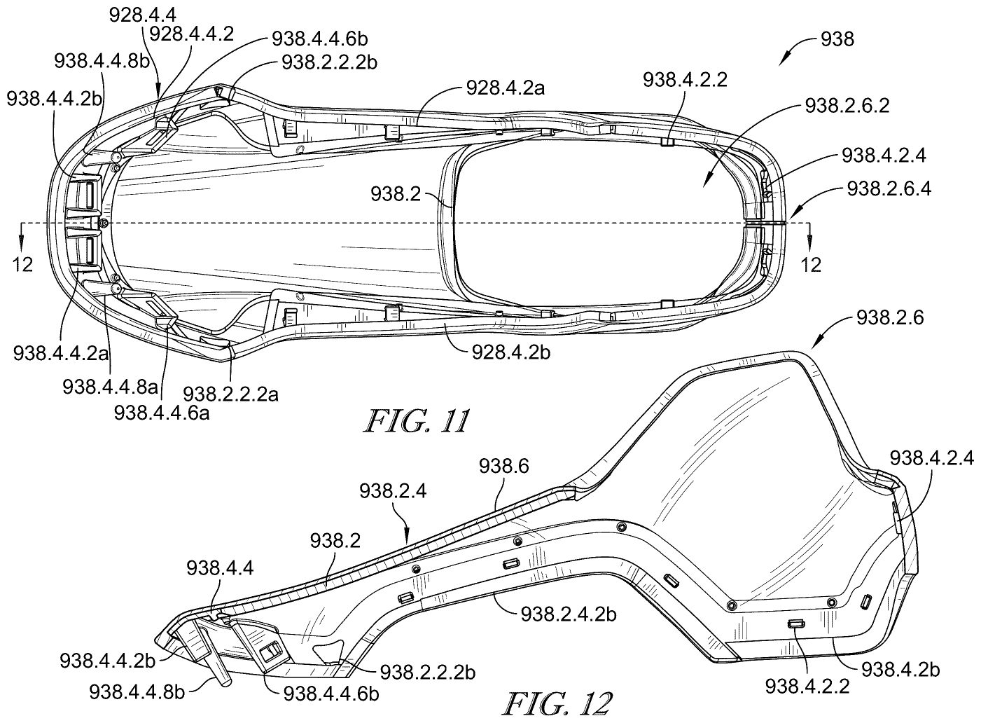

Referring to FIGS. 6-15, the foot cover 938 may be a component of the exterior covering assembly 1.2.16 of the robot 1. The foot cover 938 includes a semi-rigid carrier 938.2, a locking trim assembly 938.4, and a textile layer 938.6 adhered to the carrier. The foot cover 938 is shaped to resemble a shoe upper, is coupled to the interconnect assembly 928, and cooperates with the sole 926 to substantially cover the base assembly 920.2 and the talus 88. The foot cover 938 includes an opening 938.14.2 that is configured to receive an extent of the shin 84 that couples to the talus 88. The foot cover 938 is configured to be removable from the robot without removal of the leg 6 from the humanoid robot. It may include a rear slit 938.14.4 that facilitates the attachment or detachment of the foot cover 938 to the base assembly 920.2.

The foot cover 938 includes a toc box portion 938.10, an upper portion 938.12, and a rear portion 938.14. The toe box portion 938.10 substantially covers the toe structure 932. The upper portion 938.12 extends from the toe box portion 938.10 rearward to the opening 938.14.2 and along the sides from the front to the rear of each interconnect bridge 928.2.2. The rear portion 938.14 extends rearward from each interconnect bridge 928.2.2. A collar section 938.14.6 encircles the opening 938.14.2 and extends upward on each side to substantially cover an extent of the talus 88 connection to the shin 84 at the sides. The rear portion 938.14 also includes the rear slit 938.14.4 to facilitate coupling to the heel coupler 928.6, where the rear slit 938.14.4 is centered.

Similarly, the carrier 938.2 provides the general shape of the foot cover 938, having a toc box portion 938.2.2, an upper portion 938.2.4 with a contoured edge 938.2.4.2, and a rear portion 938.2.6 with a talus opening 938.2.6.2 and a rear split 938.2.6.4. The carrier 938.2 has a lower perimeter edge 938.2.12 that faces the sole 926. The carrier 938.2 may be formed of a durable material, such as a thermoplastic polymer, that is configured to couple a textile layer 938.6 to its exterior surface 938.2.10 and the locking trim assembly 938.4 to its interior surface 938.2.12 near the lower perimeter edge 938.2.12. The locking trim assembly 938.4 includes a front locking trim 938.4.4 and left and right side locking trims 938.4.2. This assembly is configured for attachment of the foot cover to internal components of the foot, specifically for attachment at a toe portion of the foot, at a heel portion of the foot, and at side portions of the foot. As illustrated in FIG. 11, the carrier 938.2 may be configured with left and right side relief openings 938.2.2.2 that substantially align with the joint coupling portions 924.2.2.2.2 of the foot frame 922. The carrier material near the toe joint is removed in these areas to minimize binding or interference when the toc structure 932 pivots inward.

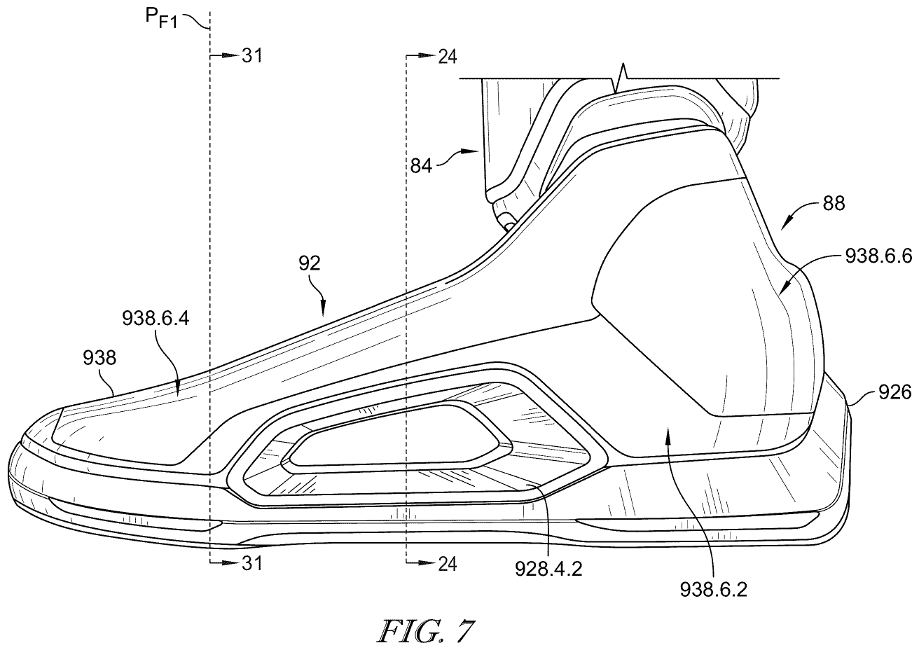

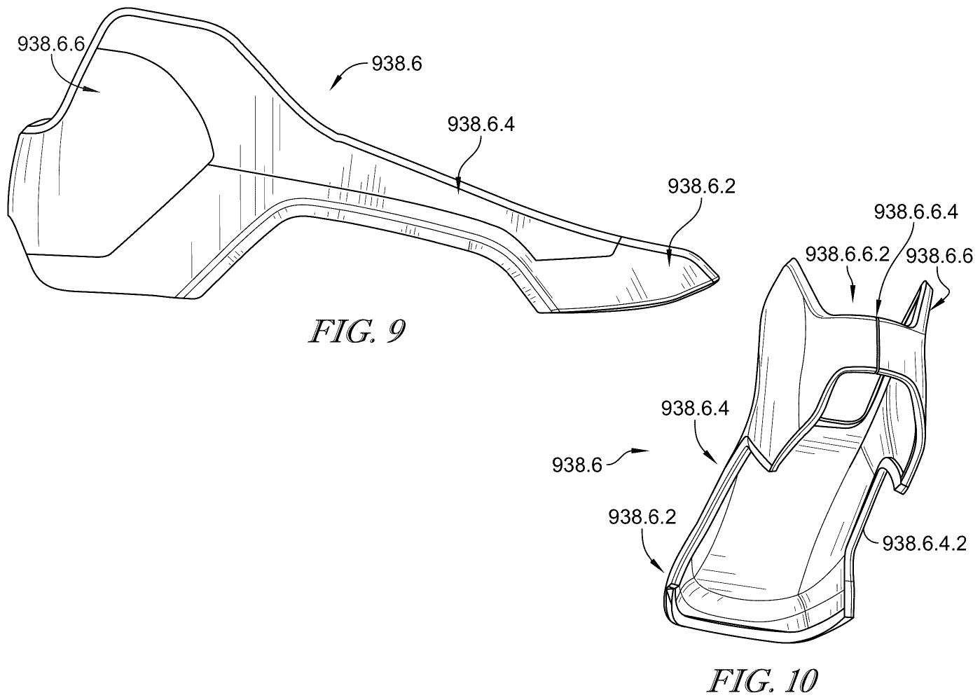

Referring to FIGS. 9-10, the textile layer 938.6 is adhered to the exterior surface 938.2.10 of the carrier 938.2 and may wrap around the edges of the carrier at the lower perimeter edge 938.2.12, the talus opening 938.2.6.2, and the rear split 938.2.6.4. The textile layer 938.6 may include one or more textile fabrics or patterns, such as various knits and weaves, to provide a combination of durability, flexibility, and aesthetic appeal. For example, as illustrated in FIGS. 7 and 9, the textile layer 938.6 may include zones that each have a different texture pattern, corresponding to different functional requirements. For example, the textile layer 938.6 may include a first zone 938.6.2 that extends along a border at the lower edge from the toc box, along the sides, to a rear portion; a second zone 938.6.4 that extends from the first zone 938.6.2 to an extent of the collar; and a third zone 938.6.6 that extends rearward from the first and second zones 938.6.2, 938.6.4 to cover the remaining portion of the carrier 938.2. The zones 938.6.2, 938.6.4, 938.6.6 may be stitched together to form the textile layer 938.6 or fabricated as a continuous textile layer without scams.

The front locking trim 938.4.4 is coupled to the interior surface 938.2.12 of the toc box portion 938.2.2 of the carrier 938.2, forward of the side relief openings 938.2.2.2. The front locking trim 938.4.4 is configured to couple with the cover coupling means 932.8.2 of the toc structure 932. The front locking trim 938.4.4 includes a front trim body 938.4.4.2 made of a semi-rigid material and having front slotted projections 938.4.4.4, side slotted projections 938.4.4.6, and alignment projections 938.4.4.8. As such, the front slotted projections 938.4.4.4 of the front locking trim 938.4.4 couple to the front locking projections 932.8.2.2 of the toc structure 932; the side slotted projections 938.4.4.6 couple to the side locking projections 932.8.2.4; and the alignment projections 938.4.4.8 are received into the alignment receptacles 932.8.2.6 for a secure fit. Each of the left and right side locking trims 938.4.2 couple with the left and right interconnect bridges 928.2 at the sides of the foot, and with the heel coupler 928.6 at the rear of the foot. The locking trim 938.4.2 includes a plurality of side locking projections 938.4.2.2 and a rear locking projection 938.4.2.4. The side locking projections 938.4.2.2 are configured to be received into the trim attachment receptacles 928.2.2.8 of the interconnect bridges 928.2.2 that are coupled to the pedestal 924. The rear locking projection 938.4.2.4 is configured to be received into the trim attachment receptacle 928.6.8 of the heel coupler 928.6.

### 3. Alternative Embodiments

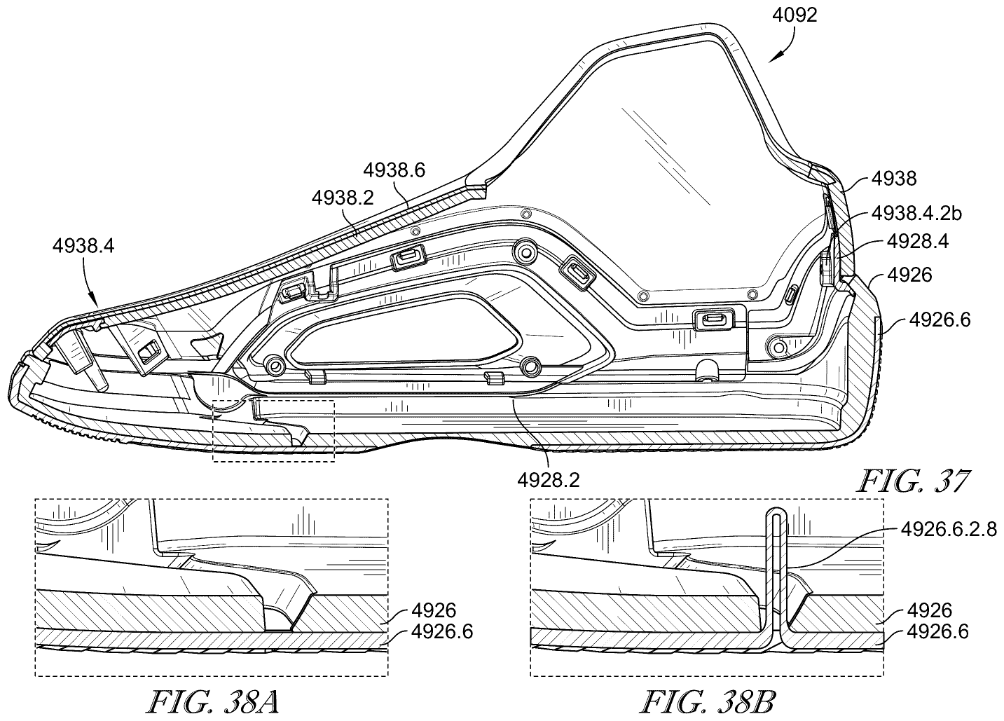

FIGS. 37-38B illustrates a first alternative embodiment, foot 4092. The primary difference between this alternative embodiment and the illustrative embodiment of foot 92 is a modification to the sole 4926, where the base assembly 4920.2 remains substantially the same as the base assembly 920.2. For sake of brevity, the above disclosure in connection with foot 92 will not be repeated below, but it should be understood that across embodiments like numbers represent like structures. In this embodiment, the outsole layer 4926.6 is a continuous layer over the gap 4926.2.6.2.8 in the sole 4926. Omitting the slit 4926.6.2.6 in the outsole layer 4926.6, helps prevent debris from inadvertently being trapped within the gap 4926.2.6.2.8. In a first example illustrated in FIG. 38A, the outsole layer 4926.6 may be made of a deformable and/or clastic material that stretches as the toe structure 4932 is displaced with respect to the pedestal 4924. In a second example illustrated in FIG. 38B, the outsole layer 4926.6 may similarly be made of a deformable and/or elastic material, with an extension portion 4926.6.2.8 of the outsole layer 4926.6 configured to (i) fold within the gap 4926.2.6.2.8 of the separation slit 4926.2.6.2, when the foot 4092 is flat and (ii) extend with the movement of the toe structure 4932 when pivoted.

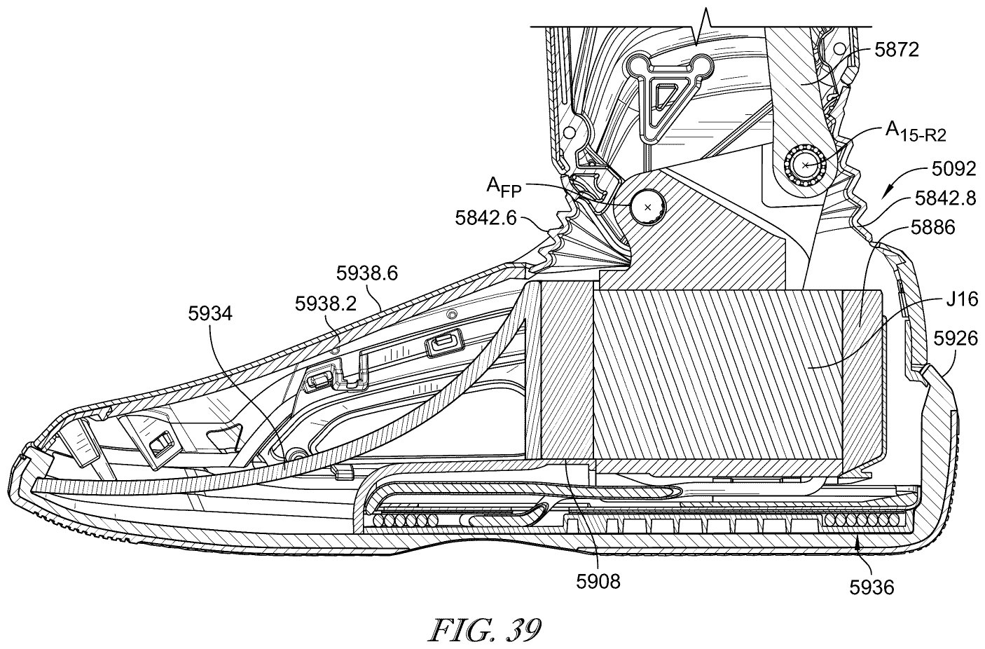

FIG. 39 illustrates a second alternative embodiment, foot 5092. The primary difference between this alternative embodiment and illustrative embodiment of foot 92 is the replacement of the toe structure and toe biasing device with a curved blade 5934 that compresses and stores potential energy. For sake of brevity, the above disclosure in connection with foot 92 will not be repeated below, but it should be understood that across embodiments like numbers represent like structures. In this embodiment, the curved blade 5934.10 is configured to be supported by the pedestal 5924 forward of the actuator mount 5930.2 and extends a front portion 5934.10.2 to be received in the front undercut groove 5926.4.2.2 of the front rim portion 5926.4.2 of the sole 5926.

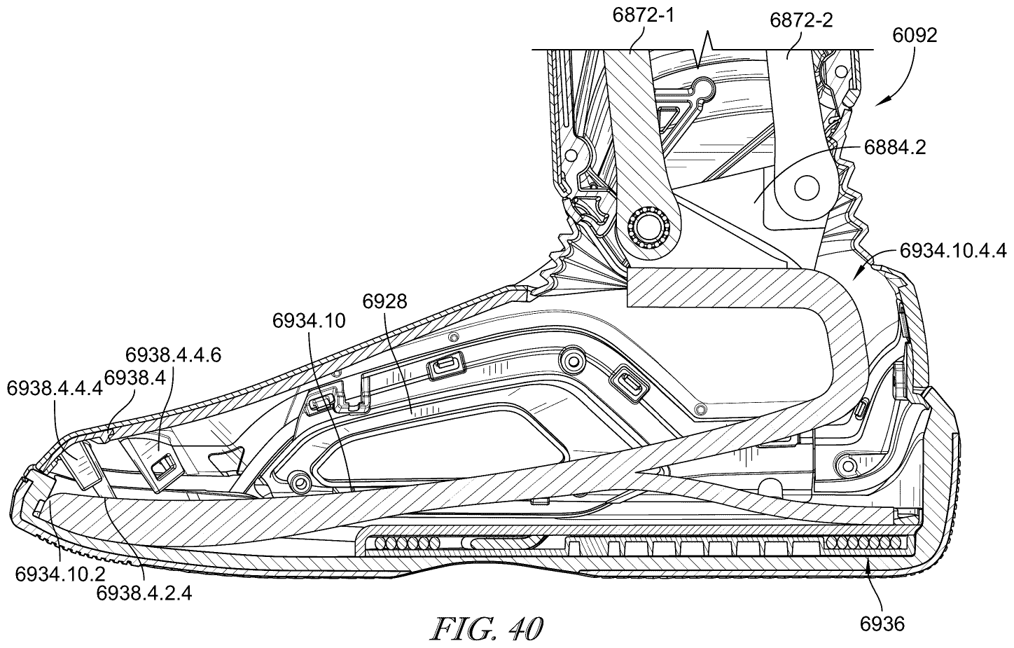

FIG. 40 illustrates a third alternative embodiment, foot 6092. The primary difference between this alternative embodiment and illustrative embodiment of foot 92 is the replacement of the foot frame with a curved blade 6934 that extends the full length of the foot 6092. For sake of brevity, the above disclosure in connection with foot 92 will not be repeated below, but it should be understood that across embodiments like numbers represent like structures. In this embodiment, a curved blade 6934.10 extends a front portion 6934.10.2 to be received in the front undercut groove 6926.4.2.2 of the front rim portion 6926.4.2 of the sole 6926, with a split support 6934.10.4 structure in the rear, with a first section 6934.10.4.2 bent downward to ensure the sole is substantially level when the robot is standing in a neutral state on a support surface, and a second section 6934.10.4.4 configured to couple to a shin coupling assembly 6884.2. Further, at least the foot roll actuator is replaced with an alternative actuator arrangement in the shin 6084 that provides first and second rods 6872-1, 6872-2 to control the pitch and roll of the foot 6092.

### 5. Material Selection

The various components that make up the robot 1 may be made of different materials, with the selection of any particular material being an important design consideration influenced by a complex balance of competing factors. These factors include, but are not limited to, mechanical performance requirements, overall weight, manufacturing cost, and manufacturability. The strategic choice of materials and their corresponding manufacturing processes is what enables a wide range of embodiments for robot 1, from conventional, cost-effective designs to advanced, functionally integrated systems with superior performance characteristics. The material selection process can be tailored to the specific operational demands of each individual component. For instance, the primary structural components that form the robot's skeleton—such as the main chassis, leg assemblies, and arm assemblies—can be formed from materials chosen to maximize the strength-to-weight ratio and stiffness, or modulus of elasticity. A high strength-to-weight ratio material may be desirable for minimizing the inertia of moving parts, which can directly reduce actuator torque requirements, lower overall power consumption, and improve energy efficiency, potentially allowing for longer mission durations or the use of smaller, lighter power sources. Concurrently, high stiffness is helpful for ensuring positional accuracy and repeatability, as a rigid structure deflects less under dynamic loads, which can help prevent imprecise movements and unwanted oscillations that could compromise task performance. This rigidity also helps to minimize structural resonance from internal sources like motor vibrations or external impacts like footfalls. In contrast, components that are exposed to higher wear and repeated impacts, such as the robot's feet or gripper surfaces, may be formed from deformable materials that maximize energy dampening to absorb shock, or from materials that maximize abrasion resistance to withstand friction and extend service life. Examples of these materials may include high-durometer polyurethanes for excellent shock absorption or casily replaceable hardened steel or carbide contact pads for exceptional durability in high-contact applications. Across all embodiments, materials may be selected to provide a predetermined operational life (e.g., at least 1,000 hours, at least 5,000 hours, at least 10,000 hours, at least 20,000, or any number therebetween) without succumbing to fatigue failure from repeated stress cycles, thereby ensuring the robot's long-term durability and structural robustness under demanding operational conditions.

A variety of manufacturing processes may be employed to fabricate the components of robot 1, with the specific process being chosen based on factors such as the selected materials, the complexity of the component design, and the anticipated production volume. For instance, additive manufacturing, also known as 3D printing, can be used for rapid prototyping or for creating complex, lightweight geometries that would be difficult or impossible to produce with traditional methods. Examples of said manufacturing method can include: Fused Deposition Modeling (FDM), Stereolithography (SLA), Selective Laser Sintering (SLS), and Direct Metal Laser Sintering (DMLS). Alternatively and/or additionally, parts, components, and/or assemblies may be manufactured using subtractive processes like Computer Numerical Control (CNC) machining, injection molding, casting (e.g., sand casting, investment casting, and die casting), forming processes (e.g., forging, stamping, and extrusion) and/or joining processes (e.g., brazing and soldering, or adhesive bonding).

### 6. Noise Control

Robot 1 may also possess a variety of inherent noise sources in a standstill/idle state, while also generating noise during the performance of its designated tasks under both loaded or unloaded conditions. For instance, a significant source of noise in the standstill/idle state may be generated by the robot 1's internal cooling fans, while a significant source of noise during performance of a task may occur during locomotion due to the repeated contact between the feet 92 of robot 1 and the support surface PG. Each of these noise sources, and others, may be carefully analyzed and considered in order to minimize the total noise emissions from said robot 1. This noise emission minimization may be helpful in environments where the robot must operate alongside humans, enabling it to receive spoken commands from a human and/or allowing its auditory signature to indicate its presence and movement to others nearby. The following table(s) identifies exemplary noise emission ranges for the robot 1 in various states:

TABLE 1

| | Most Preferable | Preferable Noise | Maximum Noise |
|---|---|---|---|
| Robot State | Noise Level | Level | Level |
| Standstill/Idle | <30 dBA | <50 dBA | <90 dBA |
| Task (No Payload) | >15 dBA & <55 dBA | >10 dBA & <70 dBA | >5 dBA & <90 dBA |
| Task (Max Payload) | >15 dBA & <60 dBA | >10 dBA & <75 dBA | >5 dBA & <90 dBA |

It should be understood that these noise levels and states are only exemplary and may be less or more dependent on the specific operational environment, the nature of the task being performed, and the above-described robot design. Further, it should be understood that the noise emission level of Robot 1 may be specifically required to be under any value contained within the tables below or any value between the numbers contained in the above tables.
a. Locomotion

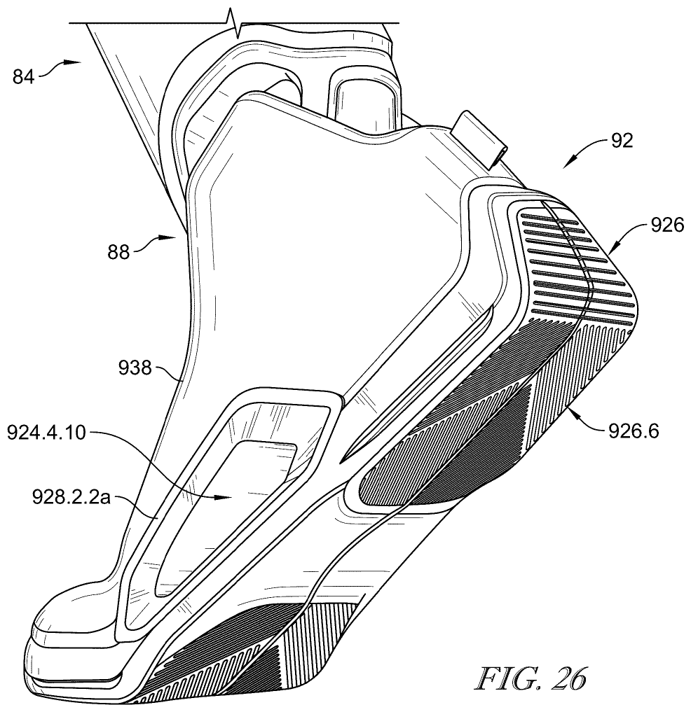

The above-mentioned noise minimization during locomotion may be accomplished by using a unique robot foot design that is constructed as a complex, multi-part assembly, as illustrated in the accompanying FIGS. 6-34. This foot interfaces with the leg assembly 6 to attenuate the transmission of noise-inducing impacts and structural vibrations through a system of carefully engineered layers. In the illustrative embodiment, each foot 92 of robot 1 comprises an outsole layer 926.6, which is arranged for direct contact with the ground; a sole 926 that is coupled to the outsole 926.6; and a base assembly 920.2 coupled to the sole 926, which facilitates the robust interface of the foot 92 with the remainder of the leg assembly 6. In some embodiments, a tunnel 924.4.10 is strategically formed through the foot 92. This tunnel can be configured to allow for the venting of the shin area and to facilitate better mechanical compliance of the foot 92 with uneven terrain. The outsole layer 926.6 can be preferably fabricated from a highly durable, high-friction, non-slip material, such as a high-durometer polyurethane elastomer (e.g., polypropylene foam). This material may be chosen for its ability to effectively dampen direct impacts and for its excellent wear resistance, thereby establishing a sturdy, stable, and long-lasting base for robot 1. In some embodiments, the outsole layer 926.6 have one or more of the properties shown in the table below:

TABLE 2

| Property | Test Method | Standard | |
|---|---|---|---|
| Hardness (Shore A) | SATRA TM205“A” | 65 ± 3 | |
| | ASTM2240 | | |
| Specific Gravity | ASTM 297 | 10-12 | g/cm³ |
| Tensile Strength | ASTM D412 | ≥120 | kg/cm² |
| Tear Strength | ASTM D624 | ≥40 | kg/cm |

| | | |
|---|---|---|
| Elongation | ASTM D412 | ≥350% |
| Abrasion | DIN/NBS | ≤120% |
| Oil Resistance | ASTM D471 (903# % oil 22 | ≤12% |
| | ITs 40C) | |
| Slip Resistance | ASTM F1677 MARK II | MARK II |
| Flex (Bending) Resistance | SATRA TM161 | Bennewart flex 30,000 times |
| | | with a crack less than 4 mm |
| Heat Resistance | NFPA 1971-2007 | ≥300° C. |
| Flame Retardance | NFPA 1971-2007 | Extinguish flame in 1 second |
| | | after 12 seconds of direct |
| | | flame |
| EH Electric Shock (mA) | ASTM F-2412-11, Clause 9 | 18,000 V, <=1 mA for 1 |
| | | minute |

The sole 926 may be configured as a deformable structure specifically designed to further absorb and dissipate impact energy, and as such they can act as a primary shock absorption layer within the foot 92. The geometry and material specifications of the sole 926 can be tuned using computational methods like Finite Element Analysis (FEA), to correspond with the nature and magnitude of the impacts typically experienced by robot 1 during its operational envelope. Said computational analysis may select or identify a specialized viscoelastic polymer like Sorbothane® from a list of other candidate materials, as a desirable material for the formation of the sole 926 due to its energy absorption properties. In other embodiments, the sole 926 could include or exclude an array of pneumatic or hydraulic bladders, or a complex lattice structure that is 3D-printed from a flexible polymer to achieve a specific, engineered response to impact forces.

Additionally, the base assembly 920.2 that interfaces the foot 92 with the leg assembly 6 may be implemented as a constrained layer damper, comprising layers of viscoelastic material bonded between stiffer structural layers. However, in a different embodiment, it could be a miniature mechanical shock absorber, comprising a coil spring and a fluid damper, or a more advanced magnetic damper that uses eddy currents to dissipate vibrational energy without physical contact. This configuration is highly effective at damping structural vibrations and preventing them from propagating from the feet 92 up through the leg assemblies 6 and into the more sensitive components in the upper body of robot 1.

b. Testing of the Acoustic Performance of the Robot

To objectively quantify its acoustic performance, robot 1 may be subjected to a variety of standardized, repeatable tests designed to measure the amount of noise it generates under different, well-defined operational states. These states may include, for example, a standstill/idle state, a task-execution state with no payload, and a task-execution state with a maximum payload, in order to build a comprehensive acoustic profile for the robot 1. Such testing may be conducted within a controlled acoustic environment, such as a semi-anechoic chamber, in accordance with established international standards, for example, ISO 9283:1998 and/or ISO 3744, the latest of both are incorporated herein by reference. In some testing embodiments, a personal noise dosimeter or a Class 1 sound level meter is positioned at a specified distance from robot 1. This distance is typically between 0.5 and 10 meters, with a preferable range of 1.5 to 6 meters, and a most preferable distance of 3 to 4 meters, to ensure accurate and repeatable far-field acoustic measurements are captured during testing.

In various advanced embodiments, the robot 1 may be configured to actively monitor its own noise output levels in real-time during operation. For this purpose, one or more sensors can be integrated directly into the robot's chassis. While one embodiment uses miniature MEMS microphones for this purpose, an alternative embodiment may use a combination of microphones and accelerometers for a more robust diagnostic capability. The accelerometers would be mounted directly to key noise-generating components (like motors or gearboxes) to detect structural vibrations at their source, allowing for more precise diagnosis of potential mechanical issues before they escalate. The captured signals from these sensors can be processed by an onboard computer. In some embodiments, this processing simply calculates a real-time dBA level to be compared against a threshold. In a more sophisticated embodiment, the system uses machine learning algorithms to analyze the full frequency spectrum of the noise and vibration signals. This advanced analysis allows it to not only detect an increase in overall noise but to classify and identify the likely source of the anomaly (e.g., “bearing wear in left knee actuator” or “fan imbalance in torso cooling unit”). This detailed diagnostic information could then be communicated to a user or a maintenance system not just as a simple warning, but as a detailed health report with recommended maintenance actions, significantly enhancing the robot's serviceability and long-term reliability.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table.

TABLE 3

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlic the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D30®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about −120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot I may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

### E. INDUSTRIAL APPLICATION

In summary, the disclosed application provides a foot that includes a unique kinematic structure wherein the foot is indirectly connected to a shin component via an intermediate talus component. A foot pitch actuator is housed within the shin to drive the talus, while a foot roll actuator is integrated directly within the talus itself, enabling independent control over foot orientation. The foot further includes a hinged toe structure that pivots relative to a main foot pedestal, biased by a passive mechanism, such as a preloaded spring and plunger assembly, which automatically returns the toe to a default position and provides controlled resistance without active power consumption. To accommodate this articulation, a deformable sole is provided, which features a U-shaped separation slit that does not extend across the full width of the sole, thereby creating a flexible joint that is substantially aligned with the mechanical hinge of the toe. The assembly integrates a wireless charging system within the foot pedestal and sole, comprising a receiving coil, shielding, and a heat transfer device for recharging a main battery. For thermal management, an internal ventilation tunnel, formed by openings in the foot's internal frame and interconnect bridges, allows for passive air circulation to dissipate heat from internal components. The entire assembly is enclosed by a removable, multi-part foot cover, consisting of a durable textile layer adhered to a semi-rigid carrier, which features a rear split and a dedicated locking trim and interconnect assembly to facilitate attachment and removal for maintenance without detaching the foot from its corresponding leg.

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as cither an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/286,240, 19/321,022, and 19/321,159; and (iii) U.S. Design patents application Ser. Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot having a leg, and wherein said leg comprises:
a foot flex actuator coupled to a connecting rod;
a foot that includes:
a pedestal having a toe coupling section and configured to pivot about a foot pitch axis in response to movement of the connecting rod;
a single toe structure: (i) having a lower curved surface, and (ii) hingedly coupled to the toe coupling section of the pedestal, the toe structure configured to pivot relative to the pedestal about a toe pivot axis; and
a passive toe biasing device configured to bias the toe structure toward an initial position relative to the pedestal.

2. The humanoid robot of claim 1, wherein the toe biasing device includes a linear compression device configured to provide a biasing force to bias the toe structure toward the initial position.

3. The humanoid robot of claim 1, wherein the toe biasing device includes a positioning rod having: (i) a first end with a first curvilinear surface positioned within an extent of the toe structure, and (ii) a second end positioned within an extent of the pedestal.

4. The humanoid robot of claim 1, wherein the toe biasing device includes a bias force adjustment mechanism that controls the magnitude of the biasing force that is applied to bias the toe structure toward the initial position.

5. The humanoid robot of claim 1, wherein the toe biasing device further includes an internal channel configured to allow air to escape the pedestal when the toe structure moves towards said pedestal.

6. The humanoid robot of claim 1, further comprising:
a sole having a front portion and a rear portion;
a separation slit formed through the sole and configured to allow relative movement between the front portion and the rear portion of the sole, wherein the separation slit does not extend across the full width of the sole.

7. The humanoid robot of claim 1, further comprising a foot cover including a carrier and a textile layer adhered to the carrier, and wherein said foot cover is configured to be removable from the robot without removal of the leg from the humanoid robot.

8. The humanoid robot of claim 7, further comprising an interconnect assembly for coupling the foot cover to the pedestal, and wherein said interconnect assembly is mechanically secured to said pedestal.

9. The humanoid robot of claim 8, wherein the interconnect assembly includes an opening formed therethrough, and wherein air is configured to be drawn into a shin and forced out of the opening in said interconnect assembly.

10. The humanoid robot of claim 1, further comprising a wireless charging assembly coupled to a lower extent of the pedestal and including: (i) a receiving coil, and (ii) a coil shield that both partially surrounds the receiving coil and is positioned between said receiving coil and the pedestal.

11. The humanoid robot of claim 10, wherein the coil shield includes nanocrystalline material.

12. The humanoid robot of claim 1, further comprising a wireless charging assembly positioned adjacent to a lower extent of the pedestal and including a heat transfer device, and wherein openings are formed in an extent of the pedestal to allow for air to be forced into contact with said heat transfer device.

13. The humanoid robot of claim 12, wherein the wireless charging assembly further includes a receiving coil that is positioned below the heat transfer device and is thermally coupled to said heat transfer device.

14. A humanoid robot having a leg, and wherein said leg comprises:
a foot that includes:
a sole having a front portion and a rear portion;
a coupling portion positioned between the front portion and the rear portion; and
a separation slit formed in the coupling portion, and wherein the separation slit: (i) is configured to allow relative movement between the front portion and the rear portion of the sole, when the foot moves from an initial position to a flexed position, and (ii) does not extend across the full width of the sole.

15. The humanoid robot of claim 14, wherein the separation slit includes a central slit section, a left side slit section, and a right side slit section, and said left and right side slit sections extend from the central slit section, and an angle is formed between an extent of the left and right side slit sections and the central slit section.

16. The humanoid robot of claim 15, further comprising a first separation slit width that extends from a first side point located within the left side slit section to a second side point located within the right side slit section, and a second separation slit width that extends from a first central point located on a left extent of the central slit section to a second central point located on a right extent of the central slit section, and wherein the first separation slit width is greater than the second separation slit width.

17. The humanoid robot of claim 14, further comprising: (i) a toe structure coupled to the front portion of the sole, and (ii) a platform coupled to the rear portion of the sole, and wherein: (i) an extent of the toe structure is externally visible when the foot is in the flexed position, and (ii) the extent of the toe structure is not externally visible when the foot is in the initial position.

18. The humanoid robot of claim 17, wherein the toe structure includes a rear portion with a curvilinear extent, and the platform includes a front portion with a curvilinear extent that substantially matches the curvilinear extent of the rear portion, whereby allowing the two portions to slide relative to one another when the foot moves from the initial position to the flexed position.

19. The humanoid robot of claim 14, further comprising a toe biasing device having a linear compression device, and wherein said linear compression device is configured to apply a biasing force on an extent of the foot.

20. The humanoid robot of claim 14, wherein the extent of the foot is a toe structure hingedly coupled to a pedestal, and wherein when a compressive force is applied on the toe structure in an amount that is greater than at least a portion of the biasing force, the toe structure pivots relative to the pedestal about a toe pivot axis.

21. The humanoid robot of claim 14, further comprising a spring configured to resist movement of a front portion of the sole relative to a rear portion of the sole.

22. The humanoid robot of claim 14, further comprising a toe biasing device: (i) that is configured to apply a biasing force to an extent of the foot, and (ii) includes a bias force adjustment mechanism that is configured to alter a magnitude of the biasing force.

23. The humanoid robot of claim 14, further comprising a foot cover that is removably coupled to the humanoid robot without removal of the leg from said humanoid robot.

24. The humanoid robot of claim 23, wherein the foot cover includes a locking trim assembly configured for attachment of the foot cover to internal components of the foot, and wherein the locking trim assembly is configured for attachment at a toe portion of the foot, at a heel portion of the foot, and at side portions of the foot.

25. The humanoid robot of claim 14, further comprising a wireless charging assembly positioned adjacent a rear portion of the sole and including: (i) a coil shield, and (ii) a receiving coil that is both partially surrounded by the coil shield and is positioned between said coil shield and the sole.

26. The humanoid robot of claim 14, further comprising a wireless charging assembly positioned adjacent to a rear portion of the sole and including a heat transfer device, and wherein openings are formed in an extent of the foot to allow for air from above the foot to be forced into contact with said heat transfer device.
